(19) United States
(12) Patent Application Publication
(10) Pub. No.: US 2025/0388041 A1
(43) Pub. Date: Dec. 25, 2025

(54) WRITING INSTRUMENT AND WRITING PART REPLACEMENT UNIT

(71) Applicant: MITSUBISHI PENCIL COMPANY, LIMITED, Tokyo (JP)

(72) Inventors: Kei OOMOTO, Tokyo (JP); Akihiro NAKADA, Tokyo (JP); Sakae NAKAMURA, Tokyo (JP); Hiroki MANO, Tokyo (JP); Hikaru HASEGAWA, Tokyo (JP)

(73) Assignee: MITSUBISHI PENCIL COMPANY, LIMITED, Tokyo (JP)

(21) Appl. No.: 18/699,472

(22) PCT Filed: Oct. 12, 2022
(86) PCT No.: PCT/JP2022/038101

§ 371 Date: Jun. 18, 2025

(30) Foreign Application Priority Data
Oct. 14, 2021 (JP) 2021-168904
May 18, 2022 (JP) 2022-081623

(51) Int. Cl. B43K 8/20; B43K 8/00; B43K 23/008; B43K 23/08

(52) U.S. Cl. CPC B43K 8/20; B43K 8/003; B43K 23/008; B43K 23/08

(57) ABSTRACT

The present invention provides a writing instrument that makes it possible to easily select a usage method in which writing defects such as line breakage or patchiness of writing (drawn line) can be suppressed or a usage method in which writing including patchiness etc. can be obtained. Provided is a writing instrument which comprises a container main body 2 for accommodating a writing ink, a writing body 7 disposed so as to block an opening part 2c of the container main body, and a cap member 4 removably fitted in the opening part and covering the writing body, and which is capable of writing on a writing surface via effusion of the ink in the container main body from the writing body, wherein: container main body is provided with a bottom part 2a, a trunk part 2b that is continuous with the bottom portion and that extends upward, and an opening part 2c that is continuous with the trunk part and that extends diagonally upward, and the angle of intersection of an axis line Ax1 of the container main body that is orthogonal to the surface of the bottom portion in the container main body and an axis line Ax2 of the opening part that passes through the center of the opening part is obtuse

### TECHNICAL FIELD

This invention relates to a writing instrument that allows one to easily select a usage that can suppress the occurrence of defective handwriting, such as scuffing and line skipping in handwriting (drawn lines), or a usage that can produce handwriting including scuffing, and writing part replacement unit that is preferably used in the writing instrument.

### BACKGROUND TECHNOLOGY

Patent Literature 1 discloses a writing instrument that contains a liquid such as paint or color and ink in a container and allows the liquid to exude from a writing body having a relatively large area with continuous pores in a synthetic resin material attached to the mouth of the container.

In the writing instrument disclosed in Patent Literature 1, a container for a liquid such as ink has a planar bottom surface allowing it to be placed on a horizontal surface and the barrel thereof is formed to be continuous with the bottom part, whose outer diameter decreases toward the top. A writing part is attached to cover the mouth formed at the upper end of the barrel.

Similar to the writing instrument disclosed in Patent Literature 1, Patent Literature 2 and 3 disclose a writing instrument in which a liquid such as ink is contained in a container, and the liquid is exuded from the writing part having a relatively large area made of a rubber sponge material, for example, attached to the mouth of the container.

In Patent Literature 2 and 3, it is recited that the disclosed container in the writing instrument has a teardrop shape. That is, the container body has an approximately spherical shape, from a part of which a narrow elongated cylindrical mouth is formed slightly protruding, and the writing part made of, for example, a sponge is attached to cover the mouth.

In each of the writing instruments disclosed in the Patent Literature, the axial lines of the container body and the mouth to which the writing part is attached are formed to be on the same line. That is, the structure of this writing instrument is on the premises designed for performing the writing, with the writing part facing downward against the surface of the paper on the desk, for example.

Thus, the ink from the container body side is smoothly supplied to the writing part facing downward, and the necessary amount of ink is smoothly supplied to the writing body having a relatively large area. Thus, a writing instrument can be provided that suppresses the occurrence of scuffing, line skipping, and uneven lines in the handwriting (drawn lines).

### CITATION LIST

### Patent Literature

PTD 1: JP-A-2006-123305

PTL 2: JP-A-2013-240895

PTL 3: JP-A-2013-240896

### SUMMARY OF INVENTION

### Technical Problem

As disclosed in the above-described Patent Literature, with the structural improvement of writing instruments and the development of ink compositions in recent years, there has been an increase in the proposal of writing instruments which makes it possible to write on a writing surface by allowing a color, paint, ink, etc. to exude from a writing part having a relatively large surface area, such as a sponge, and the demand for such writing instruments.

In line with this, various proposals have been made for this type of writing instrument with the aim of obtaining writing instruments that do not cause such things as scuffing, line skipping, or uneven lines in handwriting, by improving the ink supply to the writing part, as mentioned above.

On the other hand, there is also a latent demand to obtain handwriting and drawn lines including unique scuffing by using writing instruments that can draw thick handwriting and drawn lines.

This invention is intended to meet the aforementioned requirements and mainly aims to provide a writing instrument that allows one to easily select a usage that can suppress the occurrence of defective handwriting, such as scuffing and line skipping in handwriting (drawn lines), or a usage that can produce handwriting including such as scuffing.

### Solution to Problem

The writing instrument of this invention, which was made to solve the aforementioned problems, includes a container body containing ink for writing, a writing body arranged as to close the mouth of the container body, and a cap member detachably attached to the mouth and covering a writing body,
thereby enabling writing on a writing surface by allowing ink in the container body to exude from the writing body, wherein
the container body has a bottom part, a barrel that is continuous with the bottom part and rises upward, and a mouth that is continuous with the barrel and rises obliquely upward, and the angle of intersection between the axis of the container body, which is perpendicular to the surface of the bottom part of the container body, and the axis of the mouth passing through the center of the mouth, forms an obtuse angle.

Balls for stirring writing ink are accommodated in the container body, and the spherical diameter of the stirring balls is desirably larger than the opening diameter, facing the inside of the container, of the writing part supporting the writing body and attached to the mouth.

The writing body attached as to close the mouth is desirably made of a flexible foamed material, and titanium oxide is desirably blended in the writing ink.

In the writing instrument of this invention, the container body and the cap member attached to the mouth of the container body are preferably covered with a wrapping sheet in a state of close contact.

The wrapping sheet has a cutting line and a portion of the wrapping sheet covering the cap member side can be peeled off by the cutting line, and the cutting line is formed along the smallest cross-sectional portion of the container body between the barrel and the mouth of the container body in parallel to the bottom part of the container body.

Furthermore, in the writing instrument of the present invention, a configuration can be employed where an extension writing unit capable of receiving the ink exuded from the writing body and supplying it to the writing surface is detachably attached to the mouth of the container body as an attachment.

The writing part replacement unit preferably used in the writing instruments of this invention includes a writing part removal cap member, which is screwed onto the mouth of the container body and has an opening on the top surface;
a writing part replacement unit of the writing instruments includes a writing part removal cap member screwed to the mouth of the container body and having an opening on the top surface thereof; a writing part puller formed in a cylindrical shape, one end of which is to be inserted into the opening of the writing part removal cap member, at the one end of which a deflection portion deflectable toward the axial direction is formed, and the deflection portion has a locking portion lockable with the writing part attached to the mouth of the container body; a deflection-preventing rod that prevents the deflection movement toward the axial direction of the deflection portion by being inserted into the axial hole of the cylindrical-shaped writing part puller; and a spring member that is mounted to surround the writing part puller between the top surface of the writing part removal cap member and the other end of the writing part puller.

### Advantageous Effects of Invention

With the writing instrument of the present invention, since the intersection angle between the axis of the container body, which is perpendicular to the surface of the bottom part of the container body, and the axis of the mouth passing through the center of the mouth of the container body, forms an obtuse angle, sufficient ink can be supplied to the writing body disposed at the mouth of the container body when writing with the bottom part of the container body in the up position against a vertical writing surface, for example.

The ink supply to the writing body is limited when writing by placing the bottom part of the container body down.

Thus, a writing instrument can be provided, by changing the position of the container body when writing, which allows one to select a usage that can suppress the occurrence of defective handwriting, such as scuffing and line skipping in handwriting (drawn lines), or a usage that can produce handwriting including scuffing intentionally.

In addition, by attaching an extension writing unit to the writing instrument as an attachment, various unique writing forms can be placed on the writing surface by the extension writing unit with the ink exuded from the writing body of the writing instrument.

The writing body attached to the mouth of the container body constituting the writing instrument can be easily detached by using the writing part puller having the deflection preventing rod mounted with the writing part replacement unit of the present invention. Accordingly, the writing part replacement unit to be used in the writing instrument can handle the damage to the writing body and the refilling of ink to the container body as the barrel and contributes to the continuous use of the writing instrument.

### BRIEF DESCRIPTION OF DRAWINGS

FIGS. 1A through 1E show the external configuration of the entire writing instrument of the present invention; FIG. 1A is a front view, FIG. 1B a side view, FIG. 1C a rear view, FIG. 1D a top view, and FIG. 1E a bottom view.

FIGS. 2A and 2B also show the external configuration of the entire writing instrument; FIG. 2A is a perspective view seen along the right side from the front side, and FIG. 2B is a perspective view seen along the rear side from the right side.

FIG. 3 is an enlarged vertical cross-sectional view of the entire writing instrument cut at the center.

FIGS. 4A and 4B show the external configuration of the writing instrument covered with a wrapping sheet; FIG. 4A is a perspective view showing the state of the whole writing instrument covered, and FIG. 4B is a perspective view of the state of the wrapping sheet partially peeled from the cutting line.

FIGS. 5A to 5C is an assembly drawing of the writing part to be mounted to the mouth of the container body; FIG. 5A is a perspective view seen from the writing body side at the front, FIG. 5B a central cross-sectional view, and FIG. 5C is a perspective view seen from the rear side.

FIGS. 6A through 6D show a single-article configuration of the valve seat member; FIG. 6A is a side view, FIG. 6B a vertical cross-sectional view, FIG. 6C a perspective view seen from the front side, and FIG. 6D a perspective view seen from the rear side.

FIGS. 7A through 7D show a single-article configuration of the valve member; FIG. 7A is a front view, FIG. 7B a side view, FIG. 7C a perspective view seen from the front side, and FIG. 7D a perspective view seen from the rear side. FIGS. 8A through 8C show a single-article configuration of the writing body; FIG. 5A is a perspective view seen from the front side, FIG. 8B a perspective view seen from the rear side, and FIG. 8C a central vertical cross-sectional view,

FIGS. 9A through 9C illustrate the state where the writing body shown in FIG. 8C is partially deformed by being attached to the writing instrument; FIG. 9A is a front view, FIG. 9B a side view, and FIG. 9C a central vertical cross-sectional view.

FIGS. 10A through 10C show a single-article configuration of the supporting ring for the writing body; FIG. 10A is a rear view, FIG. 10B is a perspective view seen from the rear side, and FIG. 10C a central cross-sectional view.

FIGS. 11A through 11C show a single-article configuration of the cap member; FIG. 11A is a perspective view seen from the front side, FIG. 11B a central cross-sectional view, and FIG. 11C a perspective view seen from the rear side.

FIGS. 12A and 128 show the state of the writing instrument in use; FIG. 12A is a side view illustrating an example of writing with the bottom part of the container body in the up position and FIG. 12B is a side view illustrating an example of writing with the bottom part of the container body down.

FIG. 13 is a perspective view of the writing instrument shown in FIG. 1A through FIG. 12B to which a first extension writing unit is attached.

FIGS. 14A through 14C also illustrate the state where the first extension writing unit is attached to the writing instrument; FIG. 14A is a front view, FIG. 14B a central cross-sectional view, and FIG. 14C a rear view.

FIGS. 15A through 15D show the first extension writing unit; FIG. 15A is a top view, FIG. 15B a front view, FIG. 15C a central cross-sectional view, and FIG. 15D a right side view.

FIGS. 16A through 16E show a single-article configuration of a holder constituting the first extension writing unit; FIG. 16A is a front view, FIG. 16B a perspective view seen from the front side, FIG. 16C a rear view, FIG. 16D a perspective view seen from the rear side, and FIG. 16E a central cross-sectional view.

FIG. 17 is a perspective view of the writing instrument to which a second extension writing unit as an attachment is attached.

FIGS. 18A through 18C also illustrate the state where the second extension writing unit is attached to the writing instrument; FIG. 18A is a front view, FIG. 18B a central cross-sectional view, and FIG. 18C a rear view.

FIGS. 19A through 19E show a single-article configuration of a holder constituting the second extension writing unit; FIG. 19A is a front view, FIG. 19B a perspective view seen from the front side, FIG. 19C a rear view, FIG. 19D a perspective view seen from the rear side, and FIG. 19E a central cross-sectional view.

FIG. 20 is a perspective view of the writing instrument to which a third extension writing unit as an attachment is attached.

FIGS. 21A through 21C also illustrate the state where the third extension writing unit is attached to the writing instrument; FIG. 21A is a front view, FIG. 21B a central cross-sectional view, and FIG. 21C a rear view.

FIGS. 22A and 22B illustrate the third extension writing unit; FIG. 22A is a front view and FIG. 22B is a central cross-sectional view.

FIG. 23 is a perspective view of the third extension writing unit in an exploded state.

FIG. 24 is a cross-sectional view of the third extension writing unit in an exploded state.

FIGS. 25A and 25B illustrate the state where a fourth extension writing unit is attached as an attachment to the writing instrument; FIG. 25A is a front view and FIG. 25B is a side view.

FIGS. 26A and 26B also illustrate the state where the fourth extension writing unit is attached to the writing instrument; FIG. 26A is a central cross-sectional view, and FIG. 26B is a perspective view seen from the front side.

FIGS. 27A through 27C illustrate the fourth extension writing unit; FIG. 27A is a rear view, FIG. 27B is a central cross-sectional view, and FIG. 27C a perspective view seen from above.

FIGS. 28A and 28B show the entire configuration of the writing part replacement unit; FIG. 28A is a perspective view and FIG. 28B is a disassembled perspective view.

FIGS. 29A through 29D show the entire configuration of the writing part replacement unit; FIG. 29A is a left-side view, FIG. 29B is a front view, FIG. 29C is a right-side view, and FIG. 29D is a vertical cross-sectional view.

FIGS. 30A and 30B show the writing part removal cap member constituting the writing part replacement unit; FIG. 30A is a perspective view with the top surface facing forward, and FIG. 30B is a perspective view with the top surface facing rearward.

FIG. 31 is a perspective view showing a single-article configuration of the writing part puller constituting the writing part replacement unit.

FIGS. 32A and 32B show the initial state before the writing part replacement unit is attached to the writing instrument; FIG. 32A is a perspective view and FIG. 32B is a vertical cross-sectional view.

FIGS. 33A and 33B show the first state where the writing part replacement unit is attached to the writing instrument; FIG. 33A is a perspective view and FIG. 33B is a vertical cross-sectional view.

FIGS. 34A and 34B show the second state where the writing part replacement unit is attached to the writing instrument; FIG. 34A is a perspective view and FIG. 34B is a vertical cross-sectional view.

FIGS. 35A and 35B show the state where the writing part is removed using the writing part replacement unit from the writing instrument; FIG. 35A is a perspective view and FIG. 35B is a vertical cross-sectional view.

FIGS. 36A and 36B show the final state where the writing part is removed from the writing part replacement unit; FIG. 36A is a perspective view and FIG. 36B is a vertical cross-sectional view.

### DESCRIPTION OF EMBODIMENTS

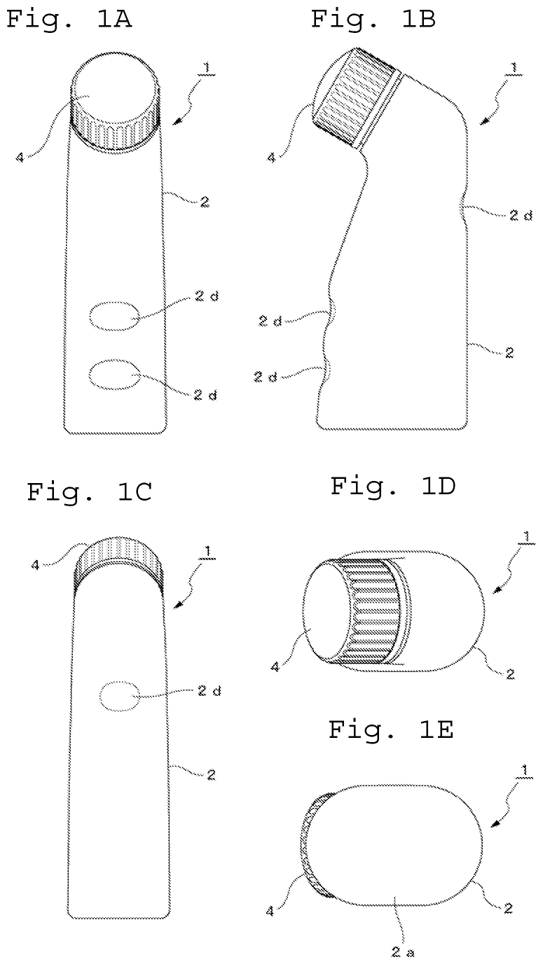

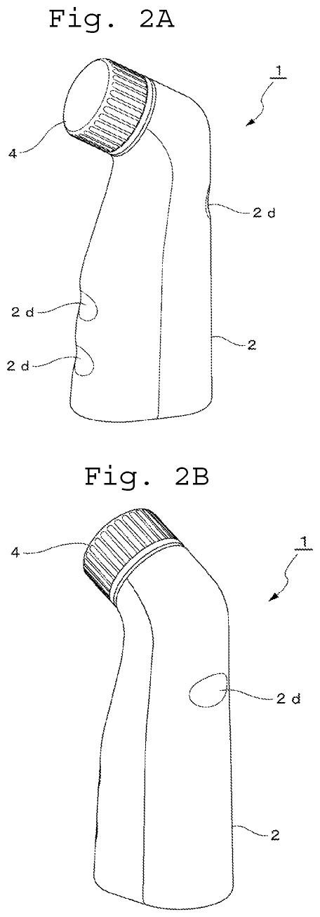

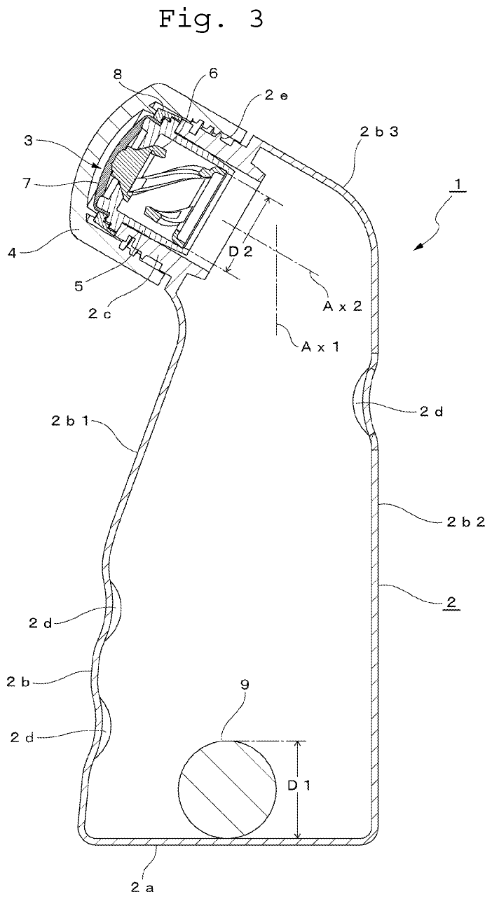

As FIGS. 1A through 1E, FIGS. 2A and 2B, and FIG. 3 show the entire configuration of the writing instruments of the present invention; among them, FIG. 3 shows the writing instrument with an enlarged cross-sectional view. Accordingly, the entire configuration of the writing instrument of the present invention will be described based on FIG. 3.

In each of the figures shown below, identical parts are indicated by the same reference signs. In some drawings, representative parts are indicated with a reference sign for the sake of space limitation. The details of each part are explained by quoting the reference signs shown in the figures that show the single article configuration.

The writing instrument 1 of the present invention is provided with a container body 2 having a bottle shape for containing ink for writing (not shown), as shown in FIGS. 1A through 1E, FIGS. 2A and 2B, and FIG. 3. The container body 2 is composed of a flat plate with an elliptical bottom part 2a (see FIG. 1E) so that it can be placed on a horizontal surface. The barrel 2b is formed with the bottom part 2a continuously rising upward.

As for the barrel 2b, the rising surface on the front side of the container body 2, i.e., the rising surface on the left side of the container body 2 shown in FIG. 3, constitutes an inclined barrel 2b1 whose diameter decreases toward the center of the container body 2 as it rises upward.

The rising surface on the rear side of the container body 2, i.e., the rising surface on the right side of the container body 2 shown in FIG. 3 constitutes the upright barrel 2b2, which is almost perpendicular to the bottom part 2a.

A neck 2b3 curved toward the front side of the container body 2 is formed at the top of the upright barrel 2b2, and a mouth 2c having a cylindrical shape rising obliquely upward along the curved surface of the neck 2b3 is integrally formed.

Thus, the angle of intersection between the axis Ax1 of the container body 2, which is perpendicular to the surface of the bottom part 2a of the container body 2, and the axis Ax2 of the mouth 2c, which passes through the center of the mouth 2c, is formed into an obtuse angle; in the example of the drawing, the angle of intersection between the axis Ax1 of the container body 2 and the axis Ax2 of the mouth 2c is set to approximately 120 degrees.

As described before, the mouth 2c is configured to be located at a position right above the inclined barrel 2b1 whose diameter decreases toward the center of the container body 2 as it rises upward.

The weight balance is considered such that the position of the center of gravity of the whole writing instrument 1 including the writing part 3 to be described later which is attached to the mouth 2c is prevented from biasing to the front side of the container body 2 on which the mouth 2c is formed.

In addition, multiple recesses for fingers 2d are formed on the front and rear sides of the container body 2, to which fingers are hooked when the container body 2 is grasped. The recesses for fingers 2d serve to prevent slipping when the container body 2 is grasped.

The container body 2 is preferably formed of flexible synthetic resin, whereby the container body 2 constitutes a squeezable container capable of being deformed by slightly pressing the right and left side faces of the container body 2 by hand.

The writing part 3, which is attached to the mouth 2c of the container body 2, has a writing body 7 to be described later, which enables writing by exuding ink from the container body 2 and is disposed in a state of closing the mouth 2c. The writing instrument 1 is configured in that the cap member 4 covering the writing body 7 is detachably attached thereto the by using the male screw 2e formed on the circumferential surface of the cylindrical portion constituting the mouth 2c.

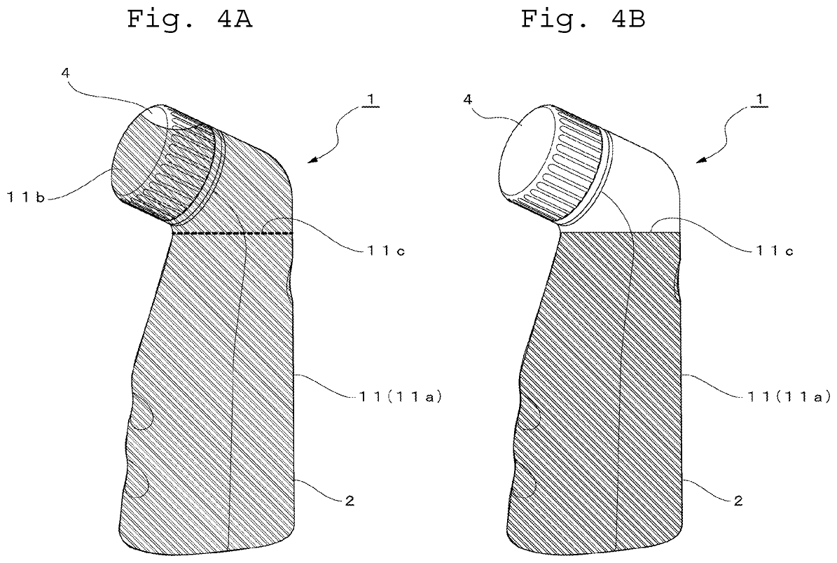

FIGS. 4A and 4B show the external configuration of the writing instrument 1 covered with a wrapping sheet 11, and in FIGS. 4A and 4B, the wrapping sheet 11 is shown by hatching.

The wrapping sheet 11 covers the outer surface of the writing instrument 1 in a close contact state with a resin sheet made of heat-shrinkability formed into a cylindrical shape. FIG. 4A shows that the writing instrument 1 is covered entirely by the wrapping sheet 11, and the product (writing instrument 1) is in an unused state, FIG. 4B shows that the cap-member-side wrapping sheet 11b to be peeled is partially separated from the body-side wrapping sheet 11a at the dotted cutting line 11c made on the wrapping sheet 11, and the product (writing instrument 1) is in a usable state.

The dotted cutting line 11c made on the wrapping sheet 11 is preferably formed on a part of the resin sheet made of heat-shrinkability in advance. The position of the dotted cutting line 11c is set to be parallel to the bottom part 2a of the container body 2 along the portion of the minimum cross-section of the container body 2 between the barrel 2b and mouth 2c of the container body 2 shown in FIG. 3 when the resin sheet is in close contact with the container body 2 by thermal shrinking.

By setting the position of the dotted cutting line 11c in this manner, most of the outer surface of the container body 2 having a particular shape can be covered with the body-side wrapping sheet 11a.

Accordingly, by printing the name of the product of the writing instrument 1 and the logo on the heat-shrinking resin sheet side for the body-side wrapping sheet 11a in advance, the writing instrument 1 marked with the product name and the logo by utilizing the large area of the body-side wrapping sheet 11a can be provided.

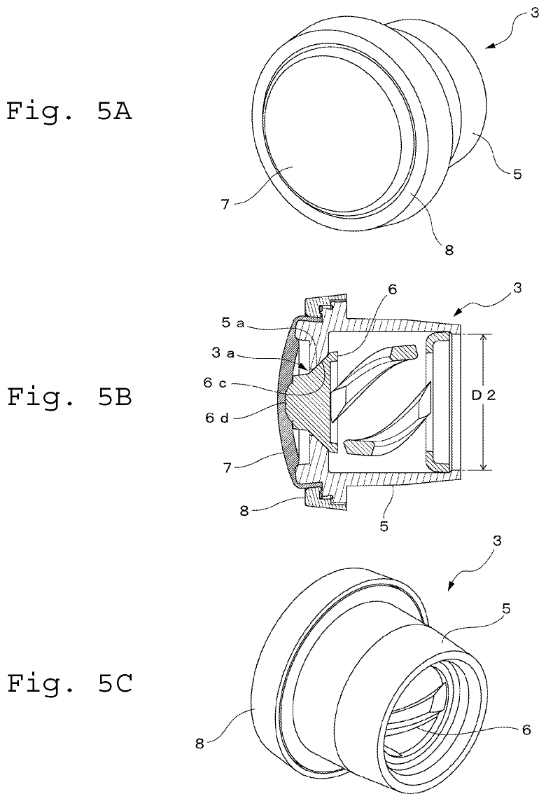

FIGS. 5A to 5C show the writing part 3 attached to the mouth 2c of the container body 2, The writing part 3 is composed of a valve seat member 5 that is cylindrically shaped and has a valve opening at the front portion, a valve body member 6 that is accommodated in the valve seat member 5 and has a valve member to which a biasing force is applied by a spring member, a writing body 7 that has a sheet shape and is attached to the front side of the valve seat member 5 and arranged in a state of covering the mouth 2c of the container body 2, and a supporting ring 8 for the writing body which attaches the periphery of the writing body 7 to the valve seat member 5.

Each of the members constituting the writing part 3 will be described based on the drawings shown in the single-article constitution below.

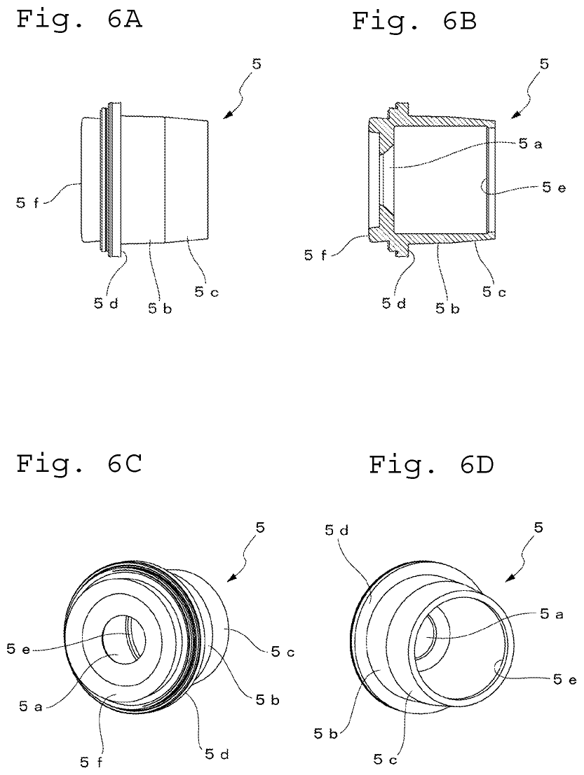

FIGS. 6A through 6D show single-article configuration of the valve seat member 5 constituting the writing part 3.

The valve seat member 5 is formed in a cylindrical shape, the front part thereof is closed, and a valve opening 5a is formed at the center. The circumferential surface of the valve opening 5a is tapered whose inner diameter decreases toward the front side. The valve body 6c having a truncated cone shape of the valve member 6, which is described later, is attached to the valve opening 5a to close the valve.

The outer circumferential surface of the valve seat member 5 is formed to have a uniform diameter along the axial direction and constitutes a fitting portion 5b into the mouth 2c of the container body 2; a tapered portion 5c is formed whose outer diameter slightly decreases from the latter half to the rear end of the outer circumferential surface. The tapered portion 5c functions as a guide to the mouth 2c of the container body 2 when the writing part 3 is attached.

A brim 5d having a larger outer diameter compared to that of the fitting portion 5b is formed on the front side of the fitting portion 5b of the valve seat member 5; the brim 5d is in contact with the front end of the mouth 2c of the container body 2 to function to position the writing part 3.

An annular locking portion 5e protruding inward is formed in the opening at the rear end of the valve seat member 5. The annular locking portion 5e functions as a stopper to prevent the coming off of the valve member 6 when the valve member 6 to be described later is mounted inside the valve seat member 5.

Furthermore, an annular protrusion 5f is formed on the front side of the valve seat member 5, which supports the writing body 7 (described below) from its rear side and serves as a positioning function for the writing element 7.

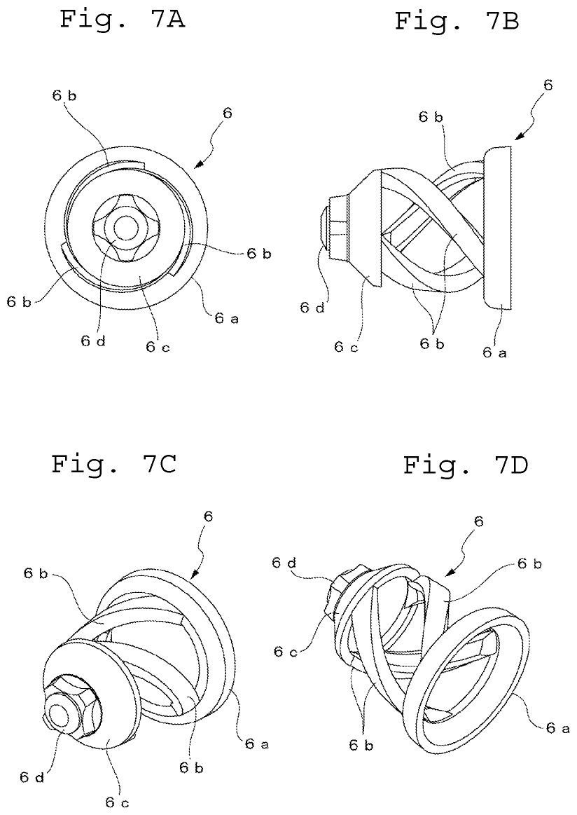

FIGS. 7A through 7D show a single-article configuration of the valve member 6 constituting the writing part 3.

The whole of the valve member 6 is integrally formed of elastic synthetic resin and is provided with three spring members 6b extending spirally upward from a ring member 6a. Each of the spring members 6b is arrayed in a circumferential direction of the ring member 6a by 120 degrees, and a valve body 6c having a truncated cone shape is formed on the upper end of the spring members 6b. Further, a valve rod 6d is formed at the center of the valve body 6c protruding from the valve body 6c.

The outer diameter of the ring member 6a is nearly equal to the inner diameter of the valve seat member 5 formed in a cylindrical shape and is formed to be slightly larger than the inner diameter of the annular locking portion 5e.

Accordingly, the ring member 6a at the rear side is accommodated inside the valve seat member 5 climbing over the annular locking portion 5e of the valve seat member 5, by pushing the valve rod 6d of the valve member 6 from the annular locking portion 5e side at the rear part of the valve seat member 5. The ring member 6a of the valve member 6 is disposed in the valve seat member 5 in the state of being locked by the annular locking portion 5e of the valve seat member 5 (See FIG. 5B.).

This causes the valve body 6c to abut on the valve opening 5a to be in a closed state, and the valve rod 6d at the center slightly protrudes forward from the valve opening 5a; namely, the inner plug (valve) 3a composed of the valve opening 5a of the valve seat member 5 and the valve body 6c of the valve member 6 is mounted on the writing part 3.

FIGS. 8A through 8C show a single-article configuration of the writing body 7 constituting the writing part 3. The writing body 7 is formed of flexible foamed sheet material. Although open-cell urethane, polyethylene material, and in addition, other rubber sponges can be preferably used for the foamed sheet, open-cell urethane is preferable from a durability standpoint.

The writing body 7, for which a material piece of foamed sheet material cut into a disk shape is used, is formed to have a spherical convex portion 7a at the center matching the shape of the front side of the valve seat member S, a short-length cylindrical portion 7b formed at the periphery of the spherical convex portion 7a, and an annular brim 7c extending outwardly at the edge of the cylindrical portion 7b.

The portion forming the spherical convex portion 7a at the center of the writing body 7 is left with the thickness of the foam sheet material described above, while the short cylindrical portion 7b and the brim 7c at the periphery are formed, for example by pressing, to be thinner than the spherical convex portion 7a.

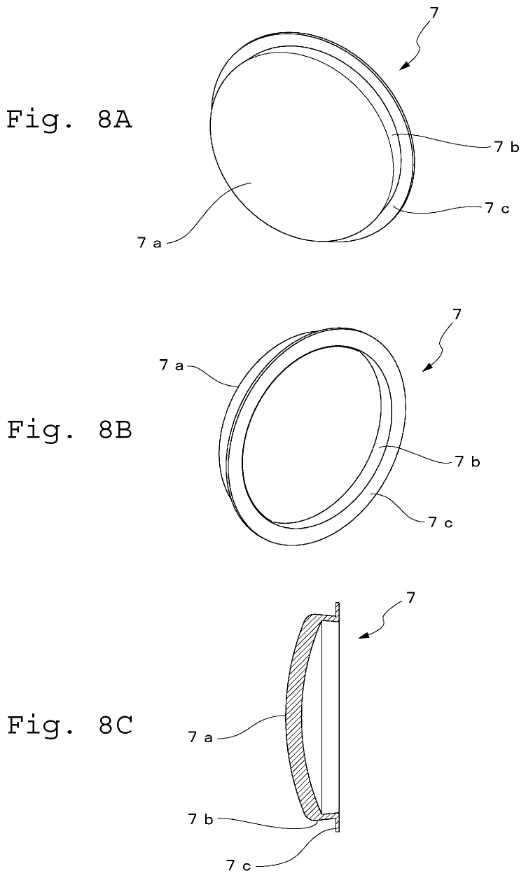

FIGS. 9A through 9C show that the writing body 7 shown in FIGS. 8A through 8C is partially deformed by being attached to the writing part 3 shown in FIG. 3.

Namely, as shown in FIG. 9c, a recess 7d is formed on the rear side of the spherical convex portion 7a, by being deformed by the tip end of the valve rod 6d protruding from the center of the valve seat member 5.

On the rear side of the spherical convex portion 7a, an annular recess 7e is formed along the inner surface of the cylindrical portion 7b to surround the recess 7d of the center. The recess 7e is deformed due to being in contact with the annular protrusion 5f protruding toward the front side of the valve seat member 5.

On the front side of the annular brim 7c, multiple recesses 7f, by being pressed and deformed by the writing body supporting ring 8 described below, are formed by multiple small protrusions 8d formed on the supporting ring 8 side. Furthermore, a groove 7g is formed by being pressed and deformed by the valve seat member 5 on the rear side of the brim 7.

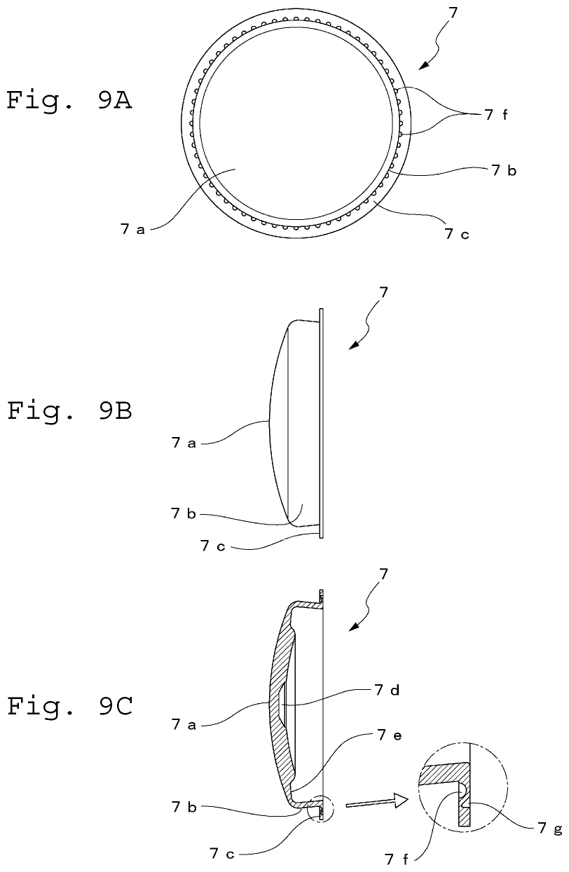

FIGS. 10A through 10C show a single article supporting ring 8 configuration of the writing body constituting the writing part 3,

The supporting ring 8 supports the planar writing body 7 along the circumferential edge by pressing the circumferential edge of the writing body 7 attached to the front surface of the valve seat member 5 along the front side circumferential edge of the valve seat member 5.

The supporting ring 8 is formed of resin material and has a tapered surface 8a whose outer diameter slightly decreases from the rear side to the front side, On the inside of the tapered surface 8a, an annular first step portion 8b and an annular Second step portion 8c are concentrically formed the inner diameters of which decrease from the rear side to the front side.

Multiple small protrusions 8d protruding rearward are continuously formed along the circumference of the second step portion 8c. Thus, the writing body 7, which is pressed. to the front surface of the valve seat member 5 by the supporting ring 8, is supported by the multiple small protrusions 8d without loosening. The supporting ring 8 is welded along the brim 5d of the valve seat member 5, thereby forming the writing part 3 shown in FIGS. 5A through 5C.

In addition, the writing part 3 is mounted to the mouth 2c of the container body 2, by using the tapered portion 5c of the valve seat member 5; the writing part 3 is screwed and attached to the mouth 2c of the container body 2 by using the locking portion 5b of the valve seat member 5. (See FIG. 3.)

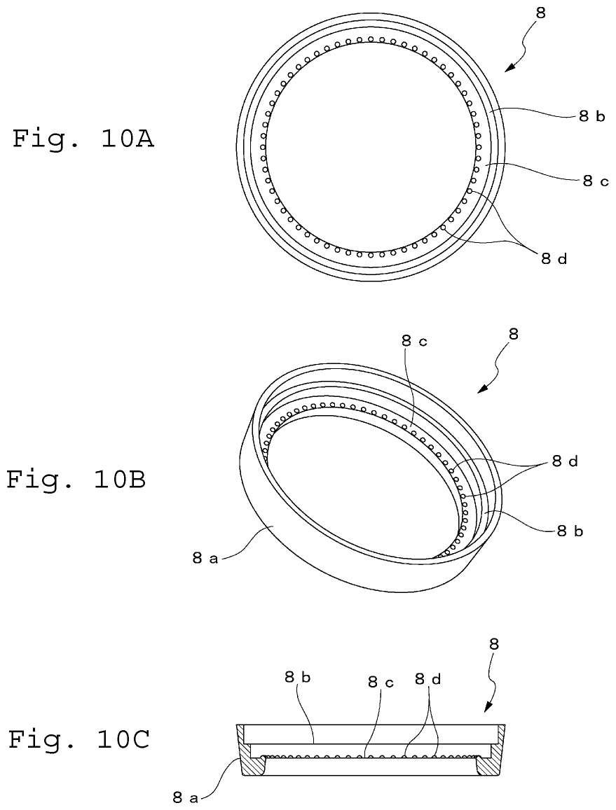

FIGS. 11A through 11C show a single article configuration of the cap member 4.

The cap member 4 is a cylinder, the upper end of which is closed by a top surface 4a, the circumference of which is continuously provided with a knurl 4b consisting of groove-like recesses in the axial direction.

In addition, the inner circumferential surface of the opening side is provided with female thread 4c, and an annular protruding ring 4d is formed to protrude in the axial direction on the rear side of the top surface 4a which is located at the depth side of the female thread 4c.

The cap member 4 can be attached to the mouth 2c by placing it on the mouth 2c of the container body 4 as shown in FIG. 3 and by screwing the female thread 4c of the cap member 4 to the male thread 2e of the mouth 2c. The writing instrument 1 can be placed in a storage state in which the writing body 7 of the writing part 3 is covered. Then, the volatilization of the ink solvent is inhibited because the protruding ring 4d inside the cap member 4 comes into contact with the writing body supporting ring 8 of the writing part 3 to seal the writing body 7.

In the writing instrument 1, writing ink (not shown) is contained in the container body 2 along with a stirring ball 9, as shown in FIG. 3.

Hard balls or glass balls are used as the stirring ball 9, and the diameter D1 of the stirring ball 9 is preferably larger than the opening diameter D2 facing toward the inside of the container body of the writing part 3 supporting the writing body 7 and attached to the mouth 2c. Namely, in this embodiment, the diameter D1 of the stirring ball 9 as shown in FIG. 3 is selected to be larger than the inner diameter D2 of the annular locking portion 5e of the valve seat member 5.

As a result, the large-diameter and heavy stirring ball 9 can effectively stir the precipitation of the colorant mainly in the writing ink used in this type of writing instrument for a relatively thick linewidth of the drawn line. This helps to prevent uneven writing (uneven coloring) in the drawn lines.

The preferred writing ink contained in container body 2 comprises at least pigment particles, wet silica, hydrous kaolin, a cohesion control agent, and water. Particularly preferred are ink compositions in which the pigment particles contain titanium dioxide and the content of the flocculation control agent is 0.05 to 1.0 mass % based on the total mass of the writing ink.

Pigment particles include inorganic pigments such as metal oxides or metal salts, as well as organic pigments such as organic pigments or rake pigments. Metal oxide particles are particularly preferred as inorganic pigment particles. Titanium dioxide is particularly desirable because it is white and can be combined with complementary color pigments (described below) to achieve a variety of colors. Furthermore, the use of titanium dioxide with its surface treated with alumina is particularly desirable because it improves dispersion stability. In addition, lustrous glitter pigments, such as aluminum pigments, can be used as pigments. The average particle diameter of the pigment particles is preferably 0.1 μm to 10 μm. The average particle diameter described in this description can be measured by the particle diameter (D50) at a cumulative volume of 50% of the particle size distribution measured by laser diffraction using a laser diffraction particle size distribution analyzer (product name of “Microtrac HRA9320-X100”, NIKKISO CO., LTD.). Unless otherwise specified, the average particle diameter refers to the average particle diameter on a volume basis. The content of pigment particles in the ink composition should be 10 to 40 mass % based on the total mass of the ink composition. If the content of pigment particles is within the above numerical range, it is possible to prevent a decrease in ink discharge performance and maintain the concealability of the ink composition and the handwriting formed by using it.

Wet silica is amorphous silica synthesized by the wet process, and is a secondary particle of several to several tens of micrometers in size of an agglomeration of relatively large primary particles of several to several tens of nanometers in size, which are difficult to form into primary particles by dispersion. In the present invention, wet silica has a larger specific surface area and more silanol groups on its surface than dry silica, and thus interacts with pigment particles to form a loosely cross-linked network. The presence of wet silica in the ink composition improves the dispersion stability of the pigment particles and also improves the redispersibility of the agglomerates because it can create loose, bulky agglomerates with agglomeration control agents and agglomeration dispersants. Meanwhile, when dry silica is used, dispersion stability can be maintained, but it is undesirable because a small amount added causes structural viscosity, resulting in high ink viscosity. Furthermore, when a paper is used as the writing surface, wet silica has a strong anti-sticking effect, preventing pigment particles from penetrating between the fibers of the paper, and when used in combination with hydrous kaolin (described below), it enhances the coloration of the brushstrokes. The average particle size of wet silica should be between 1 μm and 5 μm. When the average particle size of wet silica is within the above numerical range, stable dispersion in the ink composition becomes possible and a high sedimentation control effect of pigments can be obtained. The content of wet silica in the ink composition should be 1 to 3 mass % based on the total mass of the ink composition.

The flocculation control agent binds to the relatively low-density agglomerates formed by the wet silica described above, and can also disperse hydrous kaolin and other materials described below in the ink composition to create bulky agglomerates. This flocculation control agent prevents hard caking of the ink composition and allows the formation of bulky agglomerates, thus improving redispersibility. For example, cellulose derivatives can be used as flocculation control agents, and two or more cellulose derivatives can be used together. Cellulose derivatives include carboxymethyl cellulose, methylcellulose, hydroxyethyl cellulose, hydroxypropyl cellulose, hydroxypropyl methylcellulose, hydroxypropyl ethyl cellulose, and their salts. The content of the flocculation control agent in the ink composition should be 0.1 to 0.5 mass % based on the total mass of the ink composition.

Hydrous kaolin is a natural clay mineral, having a flat or plate-like natural clay mineral composed mainly of aluminum silicate with crystalline water, which is obtained by refining kaolin clay as a natural clay mineral. In the present invention, since the ink composition contains hydrous kaolin having a flat or plate-like particle shape, as described above, the hydrous kaolin strongly exerts a filling effect and prevents pigment particles from penetrating between the fibers of the paper, thereby further improving the color developability of the handwriting, when the paper is used as a writing surface, In addition, since hydrous kaolin is uniformly dispersed in the relatively low-density agglomerates formed by pigment particles, wet silica, and agglomeration control agents in the ink composition, it creates relatively low-density but bulky agglomerates, thus improving redispersibility compared to using calcined kaolin. In addition, since, due to the flat or plate-like particle shape of the hydrous kaolin, the particles are placed parallel to the surface of the paper during writing, and they do not scratch the surface of the paper even when overwritten, thus enabling writing without scratching the surface of the paper. The average particle size of the hydrous kaolin is preferably 0.5 to 2 μm. When the average particle size of the hydrous kaolin is within the above numerical range, the redispersibility of the ink composition and the color developability of the handwriting are improved, and scratching of the paper surface is prevented. The content of the hydrous kaolin in the ink composition should be 5 to 15 mass % based on the total mass of the ink composition. When the content of the hydrous kaolin is within the above numerical range, the too-high viscosity of the ink, hard-caking, and scratching of the paper surface when writing are inhibited. Furthermore, the concealability of the ink composition and the handwriting formed by using it can be maintained.

As for other ingredients, to the extent not affecting the performance as ink for writing instruments, resins, aggregate dispersants, extender materials, complementary color pigments, surfactants, antiseptics, wetting agents, defoaming agents, rust inhibitors, pH adjusters, foam depressants, foam absorbers, shear viscosity reducing agents and viscosity modifiers can be added as needed.

The viscosity of the ink composition is preferably in a range of 1 to 20 mPa·s. The viscosity of the compositions can be measured using a rotational viscometer (at 25° C., 10 rpm, rotational viscometer TV-20 manufactured by TOKIMEC (currently TOKYO KEIKI PRECISION TECHNOLOGY CO., LTD.)). When the viscosity of the ink composition is within the above numerical range, ink dispensability when used for writing instruments such as a marker and writing ability on an impermeable recording medium such as film are improved.

In the writing part 3 of the writing instrument 1 of the embodiment, an inner plug (valve) 3a formed by a valve opening 5a of the valve seat member 5 and the valve body 6c of the valve member 6 is mounted (see FIG. 5B.)

Accordingly, the valve rod 6d of the valve member 6 can be retracted against the biasing force of the spring member 6b through the writing body 7 by pressing the writing body 7 to the writing surface. This allows the sealing of the valve body 6c against the valve opening 5a to be broken and the ink in the container body 2 is to be supplied to and absorbed by the writing body 7 through the inner plug 3a whose valve is opened. Writing is then performed by exuding the ink from the writing body 7 toward the writing surface.

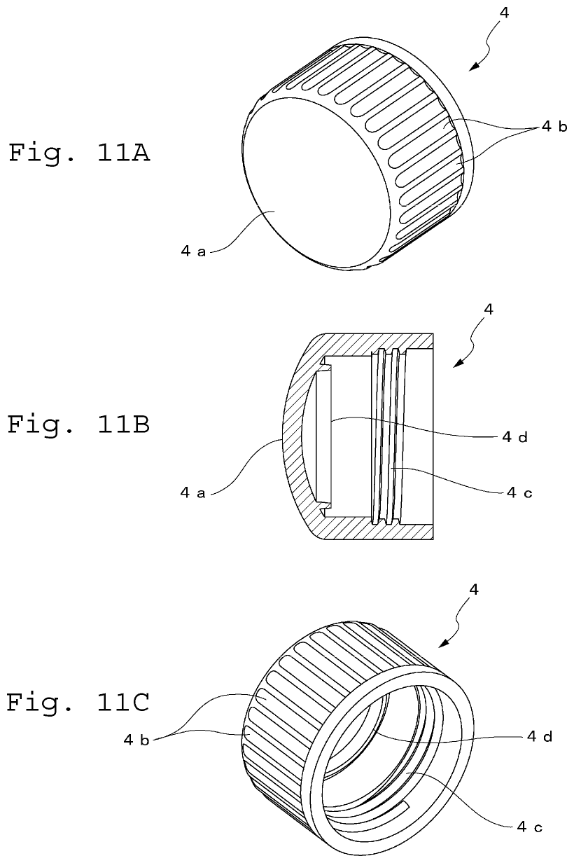

FIGS. 12A and 12B show an example of the writing instrument 1 according to the present invention in use. In this example, FIG. 12A shows the case of writing with the bottom part 2a. of the container body 2 up against the vertical writing surface 15 and FIG. 12B shows the case of writing with the bottom part 2a of the container body 2 down against the vertical writing surface 15.

When writing with the bottom part 2a of the container body 2 up against the vertical writing surface 15 as shown in FIG. 12A, the ink is sufficiently supplied to the writing body 7 disposed at the mouth 2c of the container body 2. This allows writing that inhibits the occurrence of defective handwriting, such as scuffing and line skipping in handwriting (drawn lines).

When writing with the bottom part 2a of the container body 2 down against the vertical writing surface 15 as shown in FIG. 12B, the supply of ink to the writing body 7 can be limited. This makes it possible to obtain handwriting including scuffing in handwriting (drawn lines).

In the embodiment described above, a configuration is employed in which the inner plug (valve) 3a is provided with the valve opening 5a and the valve body 6c in the writing part 3 attached to the mouth 2c of the container body 1. However, the writing instrument according to the present invention does not necessarily have an inner plug and can be also employed in a direct liquid type writing instrument in which the ink in the container body 1 is directly permeated to the writing body 7.

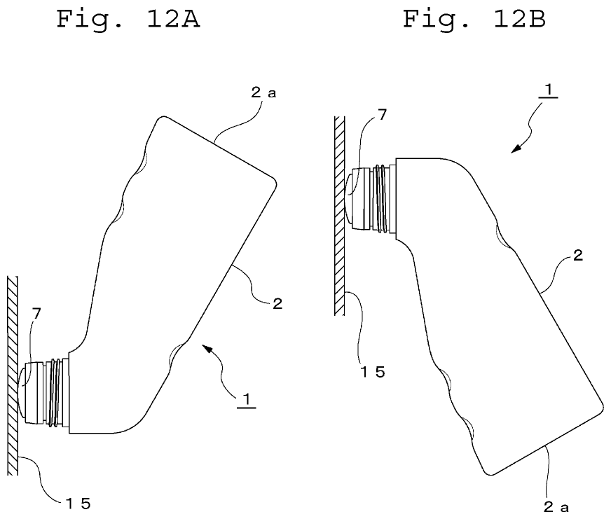

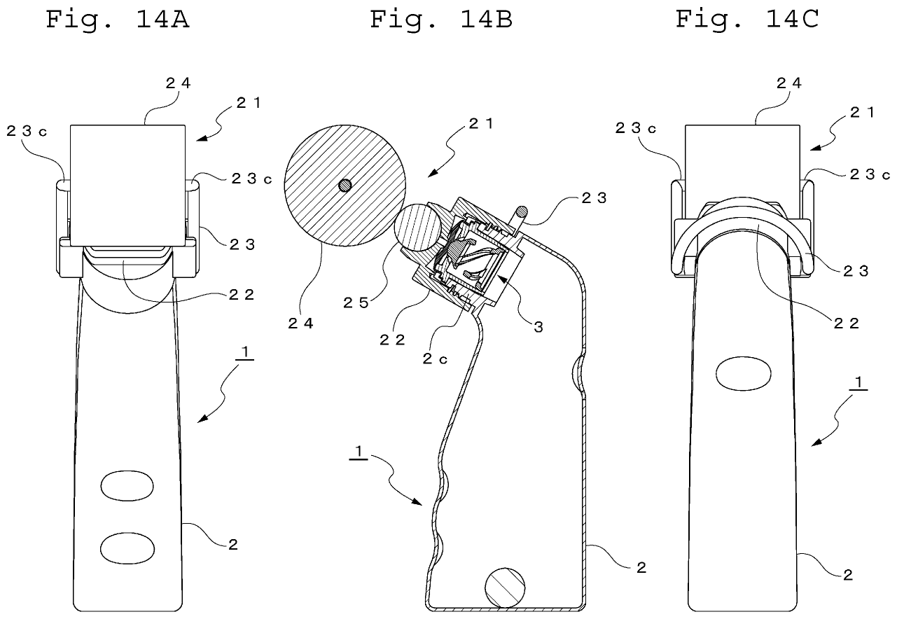

FIGS. 13 to 27C show an example that is provided with an extension writing unit detachably attached to the writing instrument 1 as an attachment, which receives the ink exuded from the writing body 7 of the writing instrument 1 and is capable of supplying the ink to the writing surface.

First, FIGS. 13 to 16E show an example of a first extension writing unit attached to the writing instrument 1 as an attachment; the first extension writing unit comprises a roller writing unit 21 attached to the mouth 2c of the container body of the writing instrument 1.

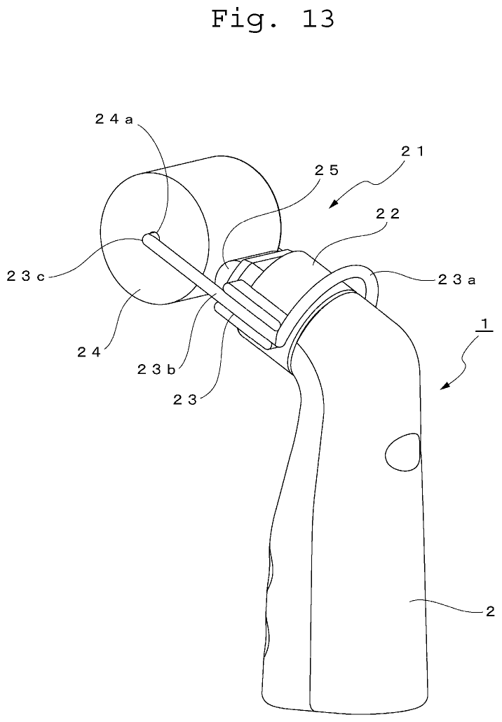

The roller writing unit 21, as shown in FIGS. 13 to 14C, is provided with a holder 22 to be attached to the mouth 20 of the container body 2 of the writing instrument 1, a support rod 23 locked to the holder 22, a writing roller 24 rotatably supported by the support rod 23, and an ink transfer roller 25, interposed between the writing roller 24 and the holder 22, delivering the ink supplied from the writing instrument 1 to the writing roller 24 side.

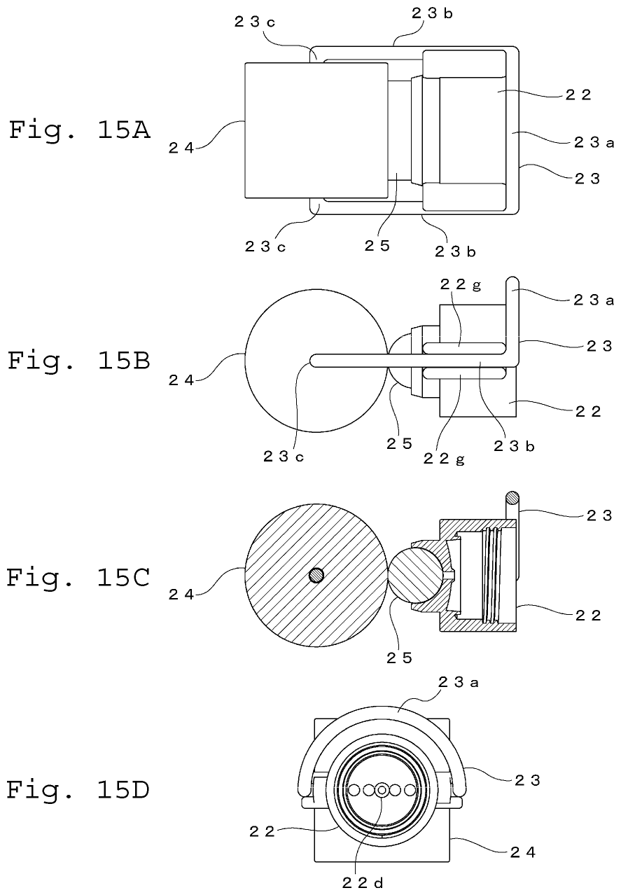

The holder 22 is entirely formed of resin material, as shown in a single-article configuration in FIG. 16. An arc-shaped concave recess portion 22a accommodating the ink transfer roller 25 is formed in the former half of the holder 22, and the latter half of the holder 22 is formed in a cylindrical shape and a female thread 22b is formed on the cylindrical inner circumferential surface. The holder 22 is detachably attached to the mouth 2c of the writing instrument 1 by screwing the female thread 22b to a male thread 2e (see FIG. 3) formed on the mouth 2c of the container body 2 in the writing instrument 1.

Five openings 22c are formed in a line manner on the inner bottom surface of the concave recess portion 22a formed on the front side of the holder 22 and they penetrate to the rear side of the holder 22. Small protrusions 22d (see FIG. 16E) are formed to surround the opening 22c of the center of the rear side. By attaching the holder 22 to the mouth 20 of the container body, the small protrusions 22d push back the valve member 6 through the writing body 7 of the writing instrument 1 and act to open the inner plug 3a (see FIG. 5B). This causes the ink from the writing instrument 1 to be supplied to the roller writing unit 21 side through the writing body 7.

A linear opening-communicating groove 22e connecting the five openings 22c is formed on the concave recess portion 22a of the holder 22, and further, arc-shaped grooves 22f are formed along the concave recess portion 22a at the respective openings 22c so as to intersect with the opening-communicating groove 22e. The opening-communicating groove 22e and the respective arc-shaped grooves 22f are for uniformly supplying the ink supplied from the writing instrument 1 to the ink transfer roller 25 accommodated in the concave recess portion 22a.

Furthermore, a pair of locking protrusions 22g being in parallel is formed on both outsides in the longitudinal direction of the concave recess portion 22a on the holder 22 toward the front-back direction of the holder 22, and a locking groove 22h is formed between the pair of the locking protrusions 22g in which the support rod 23 is fitted and fixed.

The support rod 23 is formed by bending a metal material having a round rod shape into a U-shape, and the bent central part 23a is curved into an arc shape. The bent central part 23a curved into an arc shape is disposed along the side of the holder 22.

The tip ends of the leg portions 23b of the support rod 23 supported by the locking groove 22h are bent inward toward each other. The bent portions 23c are inserted into the axial holes 24a of the writing roller 24 as shown in FIG. 13, and the writing roller 24 is rotatably supported axially.

The ink transfer roller 25, which has a smaller diameter than the writing roller 24 is accommodated in the concave recess portion 22a formed on the holder 22 and is rotatably supported by the holder 22 while being prevented from coming off from the holder 22 by abutting on the writing roller 24 on the front side.

The ink transfer roller 25 is formed of a rubber sponge, for example, which is flexible and ink-impregnable. The writing roller 24 may be suitably made of felt or other material wound around the outer circumference of a columnar base material.

The writing roller 24 of the roller writing unit 21 16 turned downward and the writing roller 24 is rolled over the writing surface, thereby the ink from the writing instrument 1 can be supplied to the writing roller 24 via the ink transfer roller 25, which is rolled by he writing roller 24. Thus, it is possible to write on the writing surface using the entire width of the writing roller 24 in the longitudinal direction.

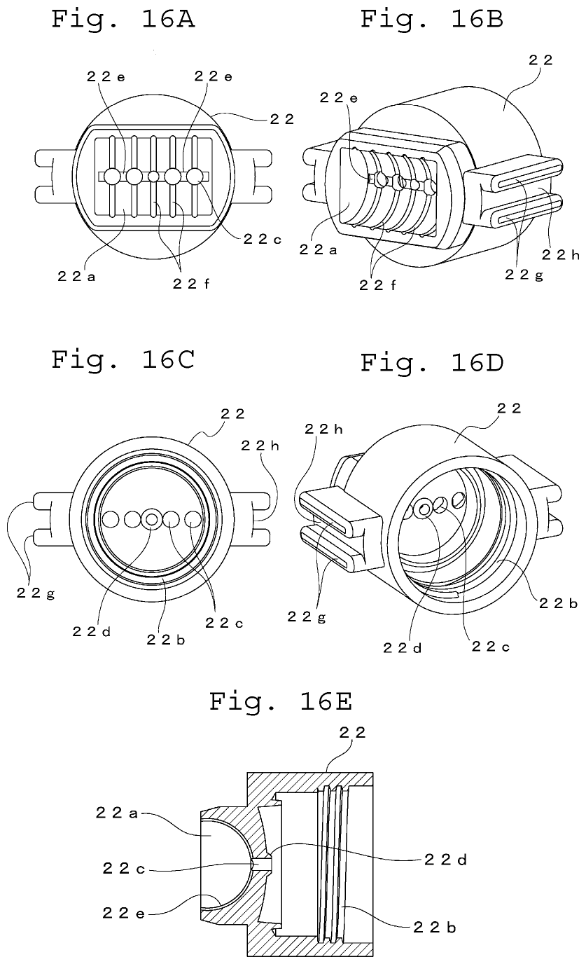

FIGS. 17 to 19E show examples of the second extension writing unit attached to the writing instrument 1. as an attachment. This second extension writing unit is composed of a thick brush unit 31 attached to the mouth 2c of the container body of the writing instrument 1 as described abo e

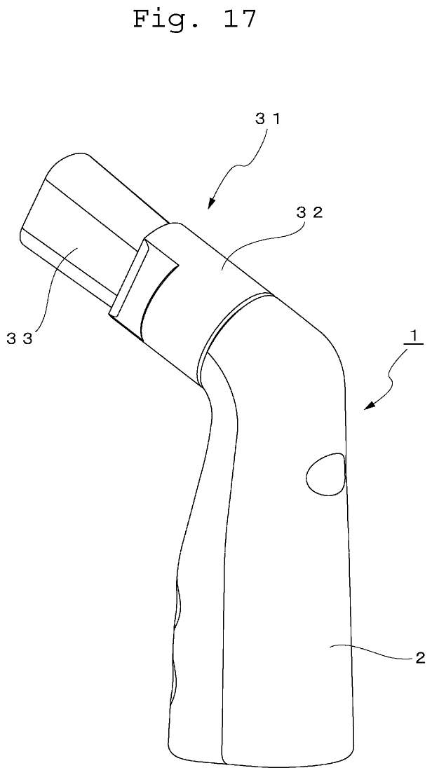

As shown in FIGS. 17 and 18, the thick brush unit 31 is composed of a holder 32 that is detachably attached to the mouth 2c of the container body 2 of the writing instrument 1 and a writing brush 33, in which natural or chemical fibers are bundled together to be formed into a prismatic shape, to be attached to the front end of the holder 32.

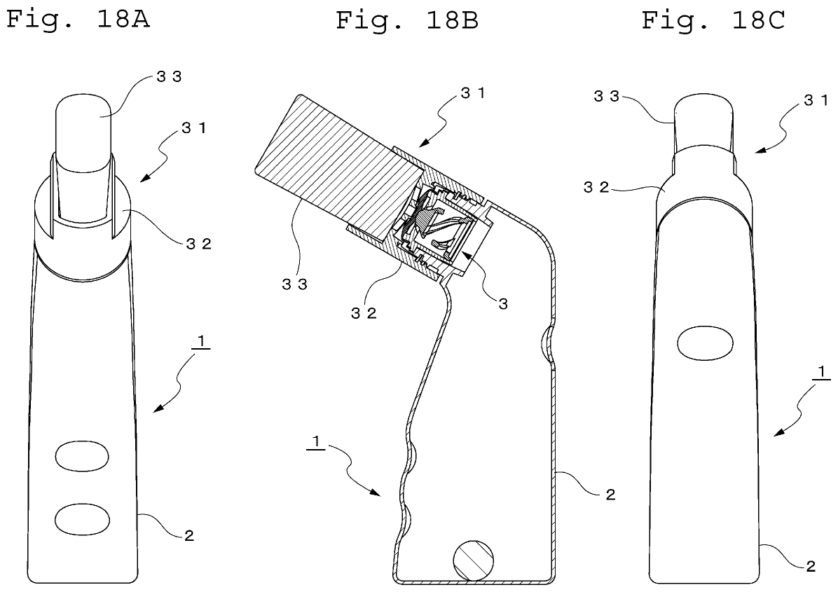

The holder 32 is molded entirely of a resin material, as shown in a single component configuration in FIG. 19. The first half of the holder 32 has a mounting opening 32a for the writing brush 33, and the second half of the holder 32 is cylindrical and has a female thread 32b on the inner circumference of the cylinder.

The female thread 32b is screwed to the male thread 2e (see FIG. 3) on the mouth 2c of the container body of the writing instrument 1, so that the holder 32 can be detachably attached to the mouth 2c of the writing instrument 1.

The rectangularly-formed brush mounting opening 32a for the writing brush 33 on the front side of the holder 32 is provided with three openings 32c at its inner bottom, each of the apertures 32c is penetrated through to the rear side of the holder 32.

Then, a small protrusion 32d (see FIG. 19E) is formed to surround the center opening 32c on the rear side. When the holder 32 is attached to the mouth 2c of the container body, the small protrusion 32d pushes back the valve member 6 through the writing body 7 of the writing instrument 1 to open the aforementioned inner plug 3a (see FIG. 5B). Thus, ink from the writing instrument 1 is supplied to the thick brush unit 31 side via the writing body 7.

The proximal base of the writing brush 33, which is made of natural or chemical fiber bundles and formed into a prismatic shape, is fitted into and attached to the brush mounting opening 32a formed into a rectangular shape on the front side of the holder 32. In this case, if necessary, an adhesive can be used to improve the strength of the attachment of the writing brush 33 to the holder 32,

In this embodiment, by directing the writing brush 33 of the thick brush unit 31 described above downward, the ink from the writing instrument 1 is supplied to the writing brush 33 through the opening 32c in the holder 32. This makes it possible to write on the writing surface with the writing brush 33.

The writing brush 33 described above is made of natural or chemical fibers bundled together and formed into a prismatic shape. The same effect can also be obtained by using a writing brush 33 made of open-cell rubber sponge or the like bundled into a prismatic shape, instead of natural fibers or chemical fibers.

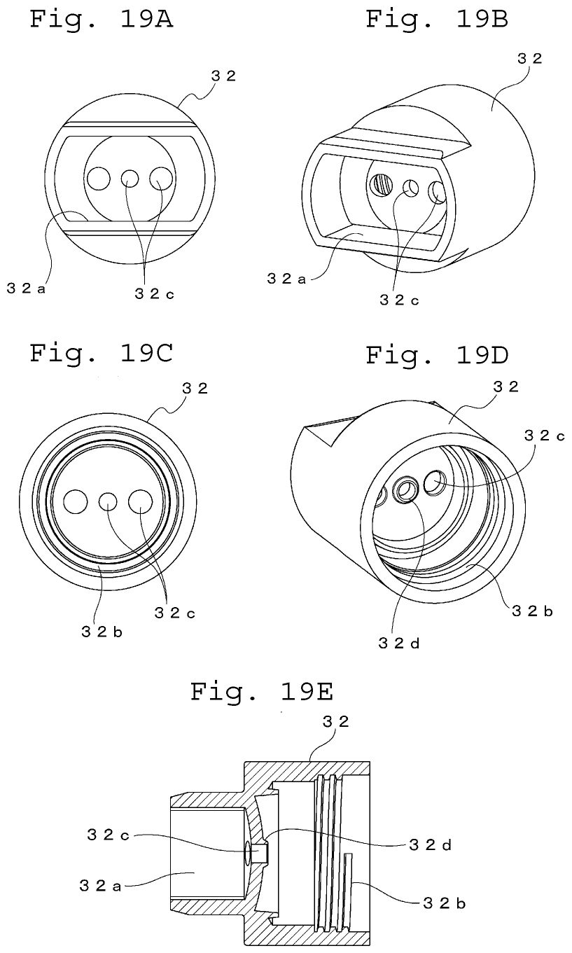

FIGS. 20 to 24 show an example of a third extension writing unit attached to the writing instrument 1 as an attachment, and this third extension writing unit is composed of a thin brush unit 41 attached to the mouth 2c of the container body 2 of the writing instrument 1.

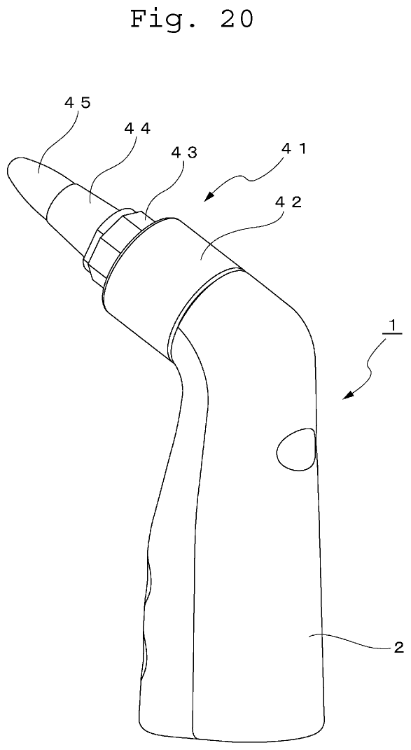

As shown in FIG. 20 and FIGS. 21A to 21C, the thin brush unit 41 is composed of first to third sub-holders 42 to 44 detachably attached to the mouth 2c of the container body 2 of the writing instrument 1 and a writing brush 45 attached to the tip end through each of the sub-holders 42 to 44 which is made of natural or synthetic fibers bound together and formed into a tapered round brush shape.

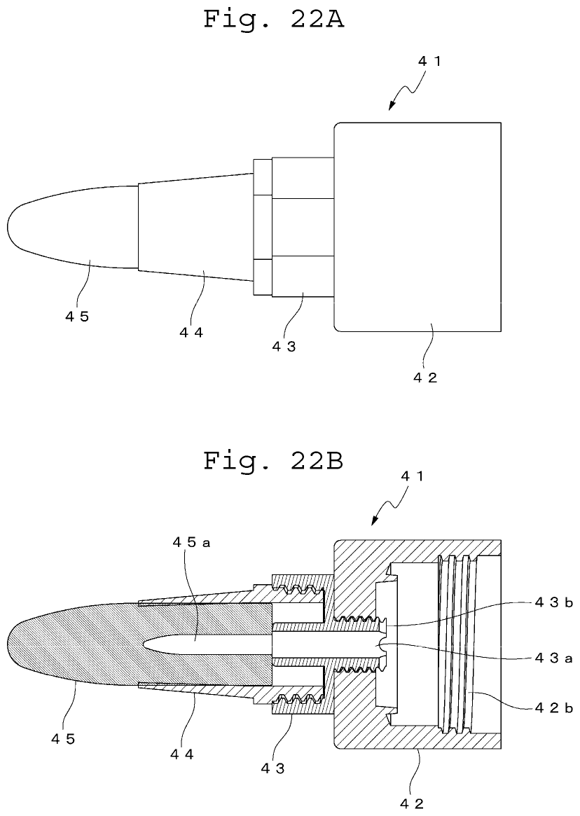

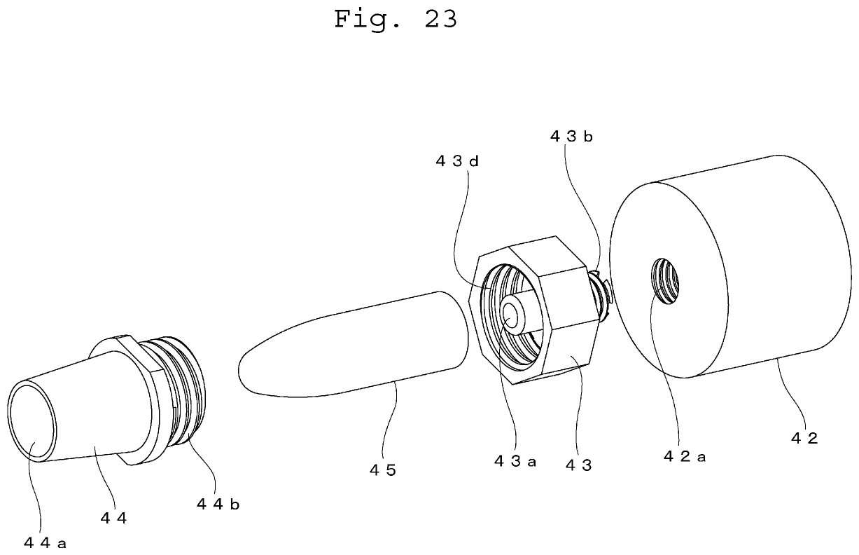

As shown in FIGS. 23 and 24, which illustrate the first to third sub-holders 42 to 44 exploded, in a single-article configuration, the first to third sub-holders 42 to 44 are made of resin material.

An opening is formed with a female thread 42a at the central portion of the front side of the first sub-holder 42 and the rear side thereof is formed into a cylindrical shape, and a female thread 42b with a larger diameter is formed on the cylindrical inner circumferential surface. The thin brush unit 41 is detachably attached to the mouth 2c of the writing instrument 1 by screwing the female thread 42b with the male thread 2e (see FIG. 3) formed at the mouth 2c of the container body of the writing instrument 1.

The second sub-holder 43 is provided with a shaft-like body 43b having a shaft hole 43a at the center, and a short cylinder 43c is formed at the front half thereof surrounding the shaft-like body 43b, and a female thread 43d is formed on the inner circumferential surface of the cylinder 43c, A male thread 43e is formed on the shaft-like body 43b protruding to the rear half portion of the second sub-holder 43.

In addition, the third sub-holder 44 is provided with a shaft hole 44a to interiorly support a writing brush 45 consisting of a tapered round brush to be described later, and the first half of the third subholder 44 is formed in a tapered shape that slightly shrinks toward the tip. The second half of the third sub-holder 44 has a male thread 44b on its periphery.

Furthermore, the writing brush 45 is made of natural or chemical fibers and bundled to form a tapered round brush shape (so-called “cannonball” shape), as described above, and an ink introduction hole 45a is formed along the axial center in the latter half of the brush,

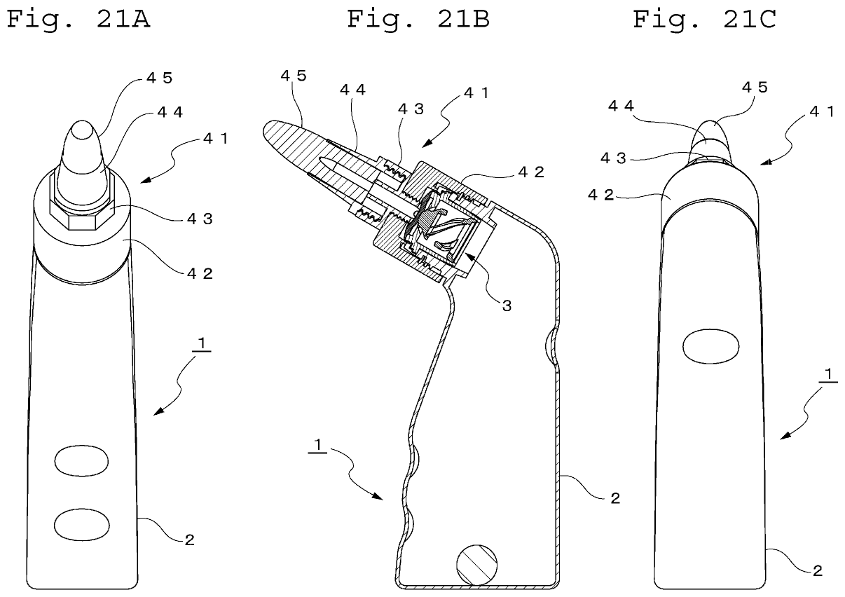

FIG. 22 shows an assembled state of the thin brush unit 41 by connecting the first to third sub-holders 42 to 44 and attaching the writing brush 45 to the tip end. An example of the assembly process is described based on FIG. 24.

First, the second sub-holder 43 is connected to the first sub-holder 42 by screwing the male thread 43e on the second sub-holder 43 into the female thread 42a formed in the center of the front face of the first sub-holder 42.

Then, the tip of the writing brush 45 is inserted into the shaft hole 44a from the rear side of the third sub-holder 44, and the male thread 44b on the third sub-holder 44 is screwed into the female thread 43d on the cylinder 43c of the second sub-holder 43.

This allows the third sub-holder 44 to be connected to the second sub-holder 43.

By this connecting operation, the writing brush 45 in the third sub-holder 44 is pushed into the shaft hole 44a of the third sub-holder 44 by the tip of the shaft-like body 43b of the second sub-holder 43. Since the shaft hole 44a of the third sub-holder 44 is tapered so as to shrink slightly toward the tip as described above, the tip of the writing brush 45 becomes to be in a state of protruding from the third sub-holder 44, and the second half of the writing brush 45 is mounted in the shaft hole 44a of the third sub-holder 44 without loosening.

The thin brush unit 41 assembled according to the above procedure is attached to the writing instrument 1 by screwing the female thread 42b on the first sub-holder 42 into the male thread 2e (see FIG. 3) on the mouth 2c of the container body of the writing instrument 1, as described above,

At this time, as shown in FIG. 22B, the rear end of the shaft-like body 43b of the second sub-holder 43 protrudes into the first sub-holder 42, and the rear end of the shaft-like body 43b pushes back the valve member 6 via the writing body 7 of the writing instrument 1, which acts to open the aforementioned inner plug 3a (see FIG. 5B).

Accordingly, ink from the writing instrument 1 is supplied to the thin brush unit 41 side via the writing body 7, and ink is supplied to the writing brush 45 via the shaft hole 43a in the second sub-holder 43 and the ink introduction hole 45a on the writing brush 45. Thus, it is possible to write on the writing surface with the writing brush 33.

The writing brush 45 described above uses the one made of natural or chemical fibers bundled and formed into a tapered round brush shape, but the same effect can be obtained by using, for example, an open cell rubber sponge formed into a tapered round brush shape instead of the natural or chemical fibers and used as a writing brush 45.

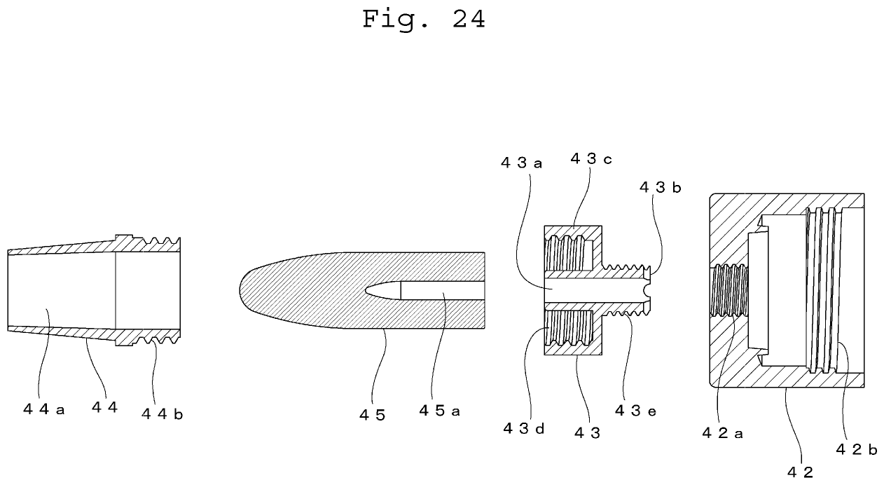

FIGS. 25A to 27C show an example of a fourth extension writing unit attached to a writing instrument 1 as an attachment. This fourth extension writing unit consists of a spattering unit 51 attached to the mouth 2c of the container body of the writing instrument 1 as described above. This spattering unit 51 consists of a unit holder 52 detachably attached to the mouth 2c of the container body 2 of the writing instrument 1, and a hand router 54 attached to the unit holder 52 and with a rotary brush 53 positioned near the mouth 2c of the container body 2.

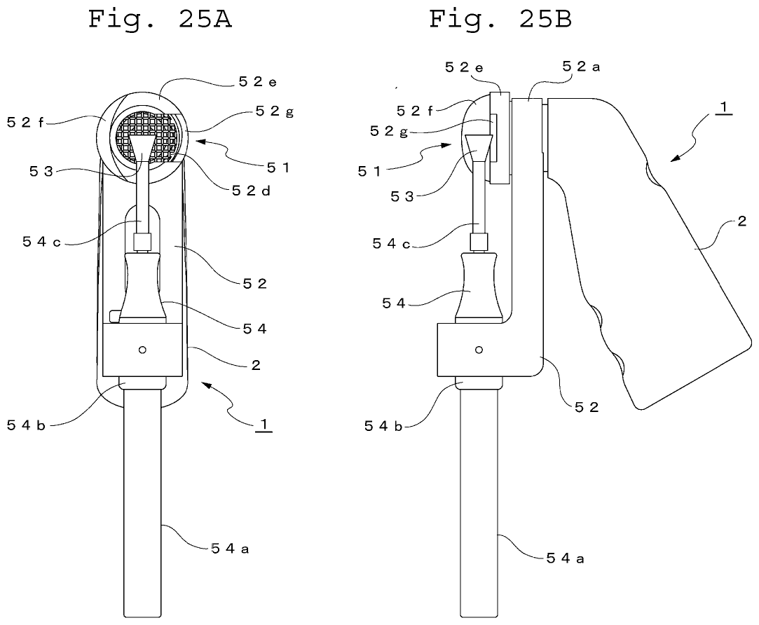

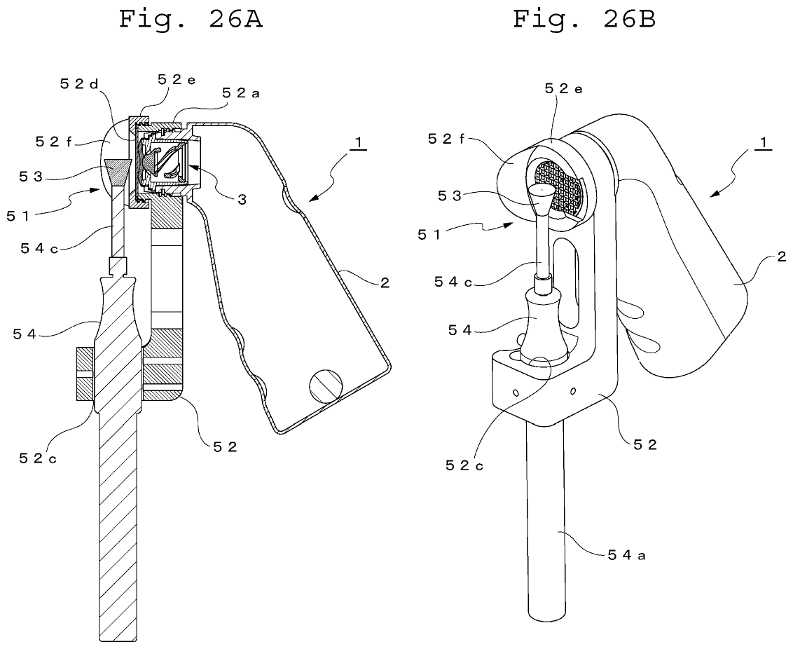

The unit holder 52 is made of resin material, for example, and is formed into an L-letter shape as a whole, as shown in FIG. 27B. A cylindrical portion 52a is formed at the top thereof, and a female thread 52b is formed on the cylindrical inner circumferential surface of the cylindrical portion 52a. The writing instrument 1 is attached to the unit holder 52 by screwing the female thread 52b with the male thread 2e (see FIG. 3) formed on the mouth 2c of the container body of the writing instrument 1 (see FIGS. 26A and 26B).

An opening 52c for mounting the hand router 54 is formed on the bottom part that is bent into an L-letter shape of the unit holder 52. The above-described rotary brush 53 of the hand router 54 mounted at the opening 52c is arranged to be located just in front of the cylindrical portion 52a of the unit holder 52.

A metal mesh 52d is disposed on the front side of the cylindrical portion 52a formed in the unit holder 52, and the metal mesh 52d is supported by a holding ring 52e screwed from the front side of the cylindrical portion 52a.

A splash guard 52f protruding toward the front side of the metal mesh is integrally formed with the holding ring 52e on one side thereof with the rotary brush 53 being centered, and a notched open portion 52g (see FIGS. 25A and 25B) is formed on the other side thereof to be flush with the front side of the metal mesh 52d.

The outer frame of the hand router 54 is formed in a long thin columnar shape, configures a battery case 54a accommodating a dry battery is formed at the bottom thereof, and a micromotor accommodating room 54b is formed at the top of the battery case 54a. The rotary brush 53 is attached to the tip end of the rotating drive shaft 54c of the micromotor disposed directing upward from the micromotor housing 54b.

In this embodiment, the hand router 54 is attached to the unit holder 52 by fitting the micromotor housing 54b into the opening 52c for mounting the hand router 54.

In the spattering unit 51, the writing instrument 1 can be attached to the unit holder 52 by screwing the male thread 2e on the mouth 2c of the container body of the writing instrument 1 to the female thread 52b in the cylindrical portion 52a formed in the unit holder 52, as described above.

When the writing instrument 1 is attached to the spattering unit 51 as described above, the metal mesh 52d disposed in the unit holder 52 pushes back the valve member 6 through the writing body 7 of the writing instrument 1, thereby opening the inner plug 3a (see FIG. 5B). As a result, ink from the writing instrument 1 exudes through the writing body 7 to the metal mesh 52d side.

In this state, the rotary brush 53 attached to the tip end of the rotating shaft 54c rotates to the right (clockwise) as viewed from the tip end side by driving the micromotor of the hand router 54 to rotate.

Due to the rotation, the tip end of the rotary brush 53 is expanded in the circumferential direction by the application of the centrifugal force and the rotary brush 53 rotates with a part thereof being in contact with the surface of the metal mesh 52d. As a result, the exuded ink to the metal mesh 52d side is splashed (spattering) in the direction along the surface of the metal mesh 52d, whereby a unique specked drawing on the writing surface can be achieved.

The notched open portion 52g is formed on the holding ring 52e for holding the metal mesh 52d on the front side in the spattering unit 51, as described above. The notched open portion 52g reduces the degree of obstruction to the splashing of the ink droplets in the direction along the surface of the metal mesh 52d, thereby contributing to the proper spattering of ink.

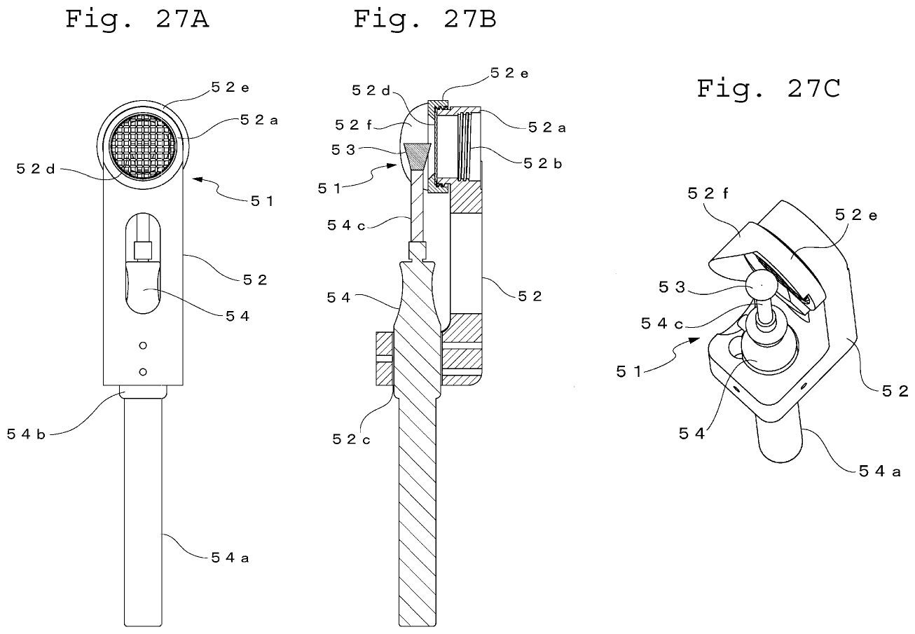

FIGS. 28A to 36B show a writing part replacement unit 61 of the present invention, which is detachably attached to the mouth 2c of the container body 2 of the writing instrument 1 shown in FIGS. 1 to 12B.

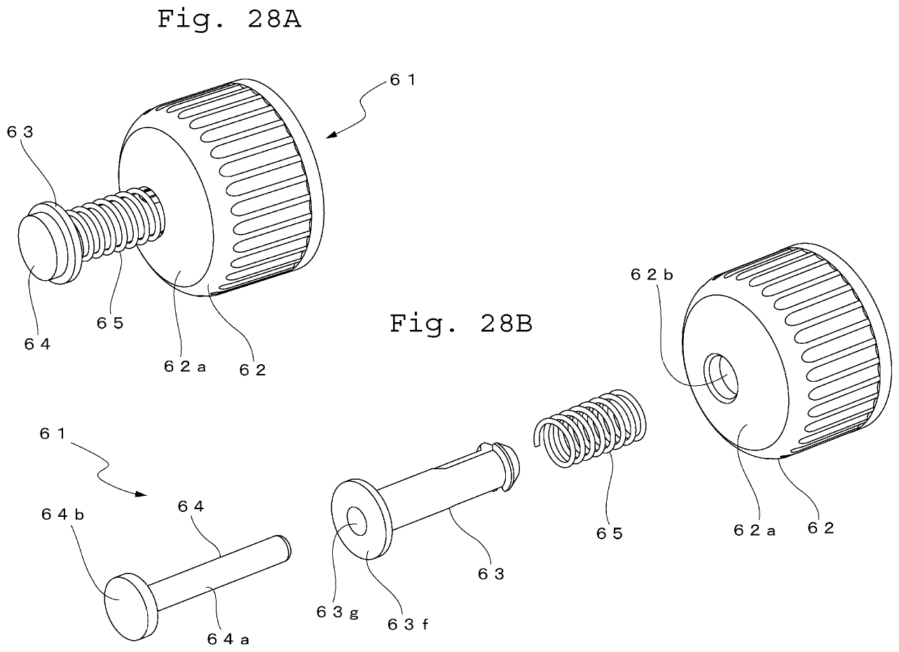

The writing part replacement unit 61 functions the writing part 3 attached to the mouth 2c to easily remove. As shown in FIGS. 28 and 29, the writing part replacement unit 61 is composed of a writing part removal cap member 62, a writing part puller 63, a deflection preventing rod 64, and a coiled spring 65.

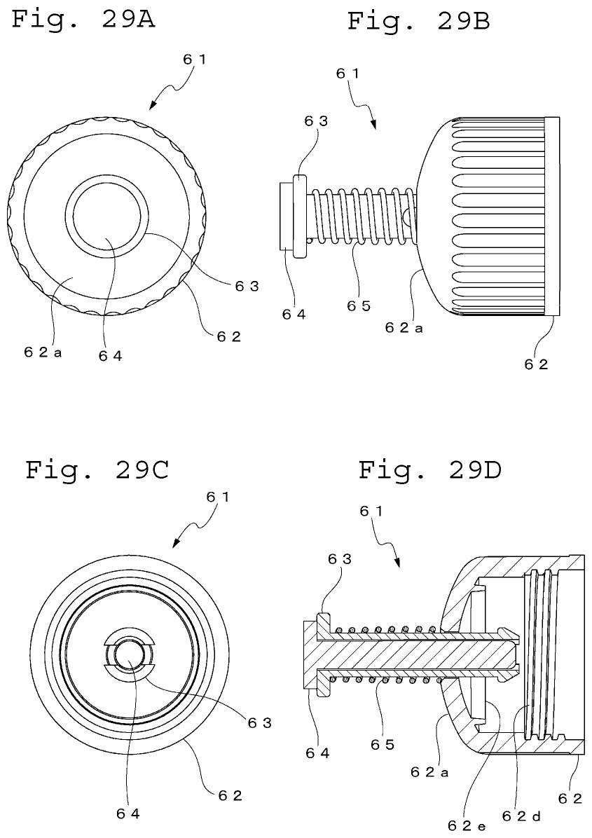

FIGS. 30A and 30B show a single-article configuration of the writing part removal cap member 62. The writing part removal cap member 62 has an opening 62b in the center of the top surface 62a, into which one end of the writing part puller 63 is inserted from the outside of the top surface 62a. The knurl 62c having groove-like recesses in the axial direction is continuously applied to the outer circumference of the writing part removal cap member 62.

A female thread 62d is formed on the inner circumferential surface at the opening side of the writing part removal cap member 62, and an anular protruding ring 62e is formed so as to protrude in the axial direction on the rear side of the top surface 62a at the deep inside of the female thread 62d.

In other words, the writing part removal cap member 62 has an opening 62b in the center of the top surface 4a of the cap member 4 as described based on FIG. 11. The other configuration is the same as that of the cap member 4 shown in FIG. 11, except for the opening 62b.

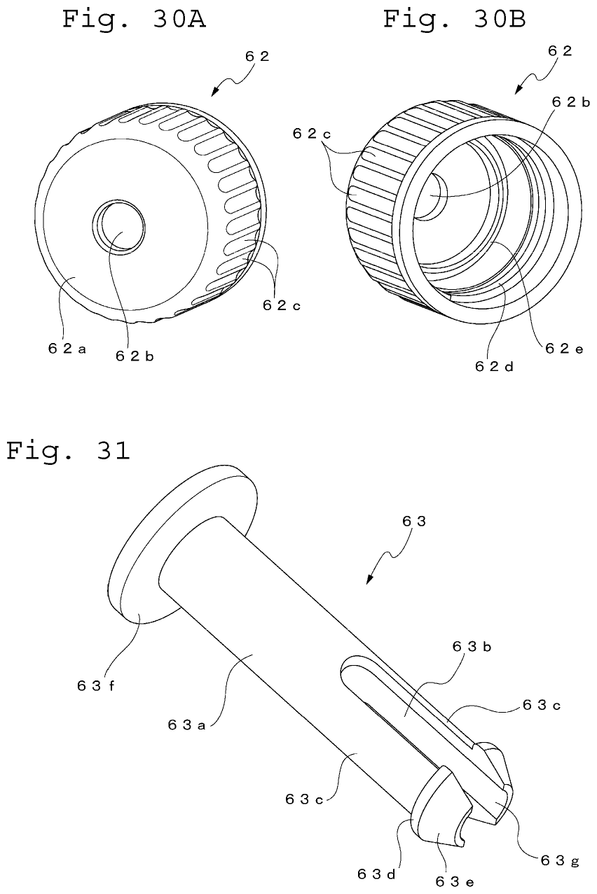

FIGS. 31A and 31B show a single-article configuration of the writing part puller 63. The principal part of the writing part puller 63 is composed of a shaft-like body 63a formed in a cylindrical shape; a pair of slits 63b is formed from the end portion at the opposite positions at 180 degrees on the cylindrical wall at one end of the shaft-like body 63a along the axial direction. Thus, a deflecting portion 63c which is bendable toward the axial direction is oppositely formed at one end of the writing part puller 63.

In addition, a locking portion 63d is formed whose diameter is enlarged than that of the shaft-like body 63a at the tip of the deflecting portion 63c, and a tapered portion 63e is formed whose diameter is tapered toward the tip of the locking portion 63d.

The other end of the writing part puller 63 has an annular brim 63f in the direction perpendicular to the shaft, and this brim 63f is provided with an axial hole 63g (see FIG. 28) communicated with the cylindrical shaft-like body 63a.

The single-article configuration of the deflection preventing rod 64 is shown in FIG. 28B; a columnar shaft rod 64a having a constant diameter in the axial direction and a disk-shaped head 64b at the end of the shaft rod 64a are formed in the deflection preventing rod 64.

The shaft rod 64a is configured to be inserted into the axial hole 63g of the writing part puller 63 with a small gap. The length dimension of the shaft rod 64a is set so that the tip of the shaft rod 64a reaches the tip of the aforementioned one end of the writing part puller 63 when the shaft rod 64a is inserted until the head 64b of the deflection preventing rod 64 contacts the brim 63f of the writing part puller 63 (see FIG. 29D).

This configuration prevents the deflecting portion 63c of the writing part puller 63 from deflecting toward the axial direction.

A single-article configuration of the coiled spring 65 is shown in FIG. 28B. The coiled spring 65 is mounted to surround the writing part puller 63. In this case, the coiled spring 65 is mounted from the tapered portion 63e side of the writing part puller 63 toward the brim 63f side at the other end thereof.

Then, by inserting the tapered portion 63e of the writing part puller 63, in a state where the deflection preventing rod 64 is not attached, into the opening 62b in the writing part removal cap member 62 from the top surface 62a side, the locking portion 63d is inserted into the opening 62b while being deflected toward the axial center.

Thus, the coiled spring 65 is mounted around the writing part puller 63 between the top surface 62a of the writing part removal cap member 62 and the brim 63f of the writing part puller 63.

The locking portion 63d of the writing part puller 63 is locked with the opening 62b while being located on the inside of the writing part removal cap member 62. Thus, the locking portion 63d functions as a coming-off stopper to prevent the writing part puller 63 from coming off from the writing part removal cap member 62.

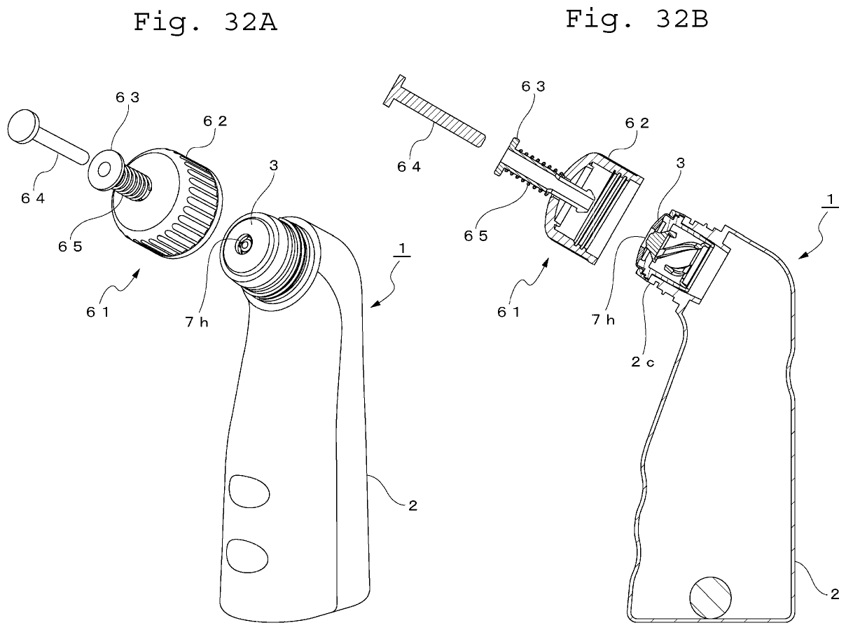

FIGS. 32A through 36B illustrate the process of detaching operation of the writing part 3 attached to the mouth 2c in order by attaching the thus configured writing part replacement unit 61 to the mouth 2c of the container body 2 of the writing instrument 1.

First, FIGS. 32A and 32B show the initial state when the writing part replacement unit 61 is attached to the mouth 2c of the container body 2. When the writing part replacement unit 61 is attached to the mouth 2c of the container body 2, a cut 7h is formed by making a cut at the center of the writing body 7 in the writing part 3 attached to the mouth 2c of the container body 2 shown in FIGS. 5A to 5C. The cut 7h is desirably an opening through which the tip portion of the writing part puller 63 can be inserted.

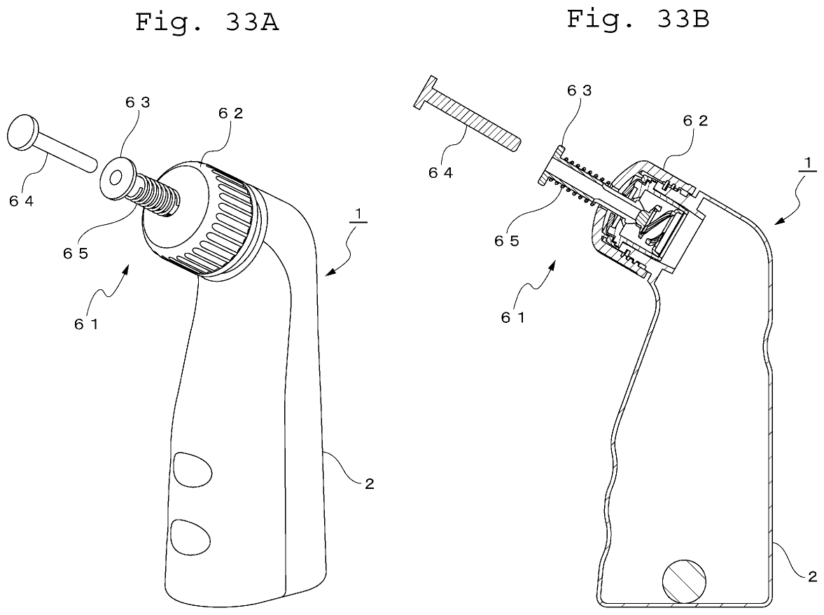

Next, in a state where the deflection preventing rod 64 is detached from the writing part puller 63, the writing part removal cap member 62 is screwed to the mouth 2c of the container body 2 as shown in FIGS. 33A and 33B. In this state, the taper portion 63e formed at the tip end of the writing part puller 63 enters the valve opening 5a of the writing part 3 (see FIG. 5B) while being deflected toward the axial direction by the action of the deflecting portion 63c by pushing the writing part puller 63 toward the writing part removal cap member 62 side against the resilient force of the coiled spring 65.

Thus, the locking portion 63d of the writing part puller 63 is inserted into the valve seat member 5 of the writing part 3, the deflection of the tapered portion 63e toward the axial-center direction is released, and the locking portion 63d is locked to the valve opening 5a of the writing part 3.

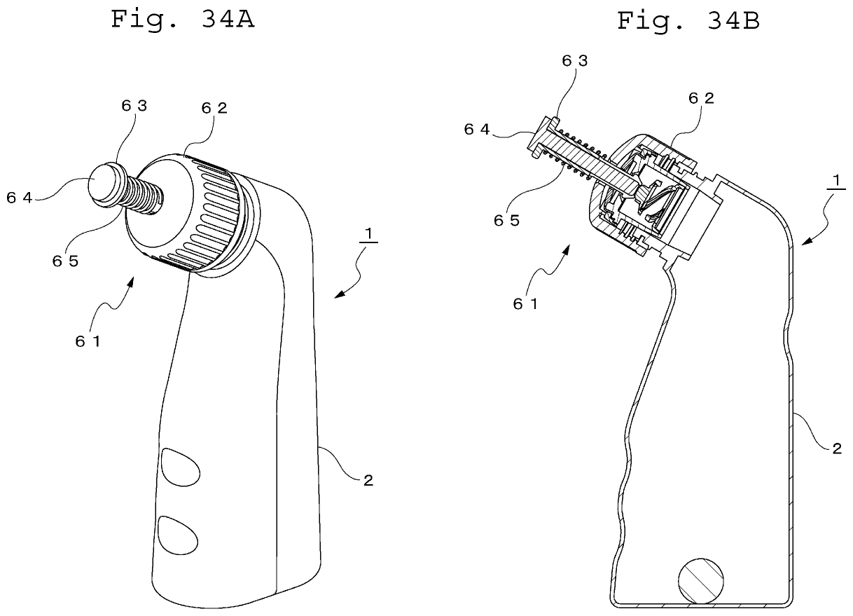

As shown in FIGS. 34A and 34B, the writing part removal cap member 62 gradually leaves from the mouth 2c of the container body 2, by inserting the deflection preventing rod 64 into the axial hole 63g of the writing part puller 63 and unscrewing the writing part removal cap member 62 screwed to the mouth 2c of the container body 2.

Meanwhile, since the deflection preventing rod 64 is inserted into the writing part puller 63, the locking portion 63d maintains the state of being locked to the valve opening 5a. Thus, the coiled spring 65 contracts in the axial direction, and the contraction of the coiled spring 65 is stopped by the abutment of the adjacent coil. Thereby, the locking portion 63d of the writing part puller 63 pulls the writing part 3 out of the mouth 2c of the container body 2.

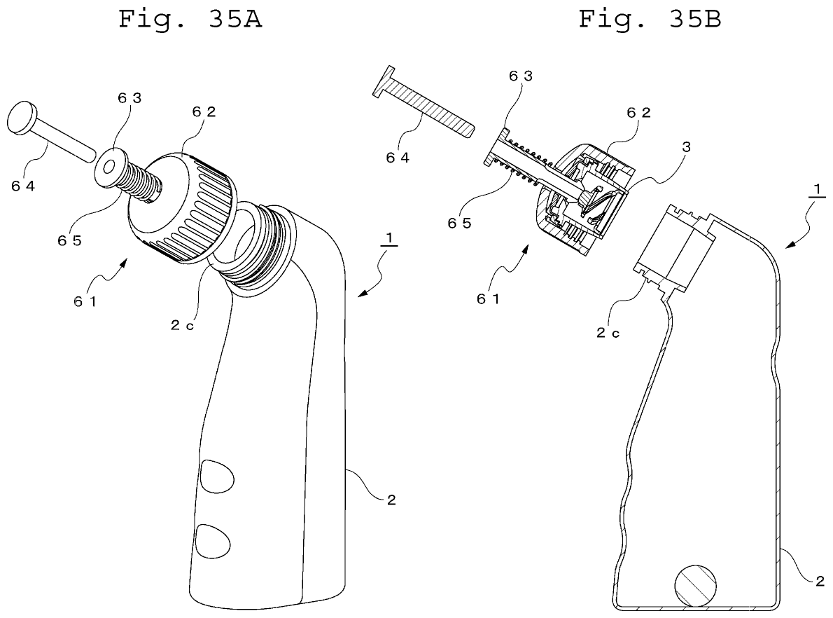

FIGS. 35A and 35B show the state in which the writing part 3 is pulled out from the mouth 2c of the container body 2 by the above-described pulling action. Then, the writing part removal cap member 62 is released from the screwed mouth 2c of the container body 2, and the writing part 3 comes to a state of being locked and attached to the writing part puller 63 side of the writing part replacement unit 61.

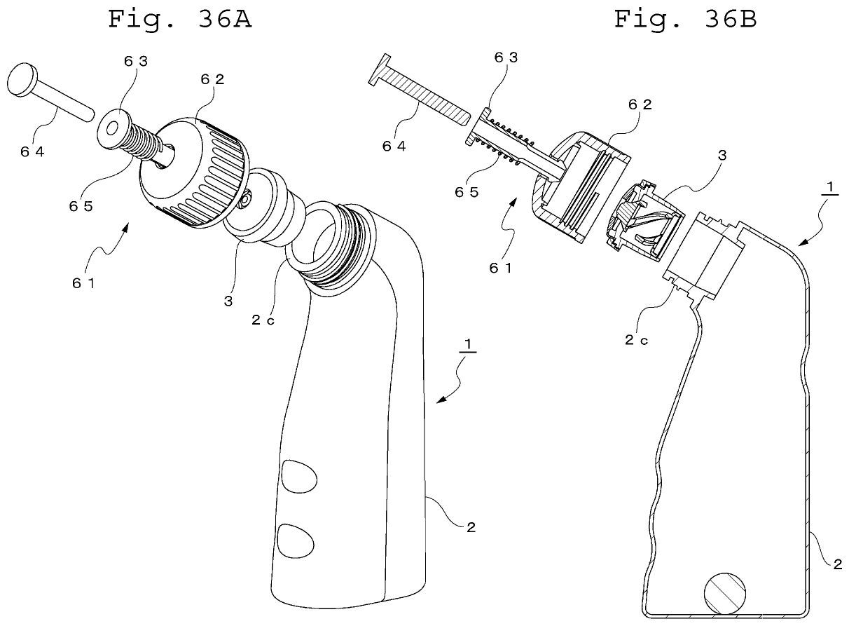

In this state, the writing part 3 is removed from the writing part puller 63 by pulling the deflection preventing rod 64 out of the writing part puller 63 and further, as shown in FIGS. 36A and 36B, withdrawing the writing part puller 63 from the writing part removal cap member 62.

In this case, since the locking portion 63d formed on the writing part puller 63 is locked to the valve opening 5a of the writing part 3 with a tapered shape as shown in FIG. 5B, in the state in which the deflection preventing rod 64 is pulled out, the locking portion 63d is easily deflected by the tapered valve opening 5a toward the axial center direction by the action of the deflecting portion 63c. This allows the writing part 3 to be easily withdrawn from the writing part puller 63.

With the writing part replacement unit 61 described above, the writing part 3 is removed from the container body 2 when the writing body 7 of the writing part 3 is worn or when ink is refilled when it has run out in the container body 2. This contributes to the continuous use of the writing instrument by mounting a new writing part 3 on the mouth 2c of the container body 2.

### REFERENCE SIGNS LIST

1 writing instrument
2 container body
2a bottom part
2b barrel
20 mouth
2d recesses for finger
3 writing part
3a inner plug (valve)
4 cap member
4a top surface
5 valve seat member
5a valve opening
5e annular locking portion
6 valve member
6b spring member
6c valve body
6d valve rod
7 writing body
7a spherical convex portion
7h cut
8 supporting ring
9 stirring ball
11 wrapping sheet
11a body-side wrapping sheet
11b cap-member-side wrapping sheet
11c dotted cutting line
15 writing surface
21 first extension writing unit (roller writing unit)
31 second extension writing unit (thick brush unit)
41 third extension writing unit (thin brush unit)
51 fourth extension writing unit (spattering unit)
61 writing part replacement unit
62 writing part removal cap member
62b opening
63 writing part puller
63c deflecting portion
63d locking portion
63g axial hole
64 deflection preventing rod
64a shaft rod
64b disk-shaped head
65 coiled spring

1. A writing instrument, comprising:
a container body containing ink for writing, a writing body arranged to close a mouth of the container body, and
a cap member detachably attached to the mouth and covering a writing body,
thereby enabling writing on a writing surface by allowing ink in the container body to exude from the writing body, wherein
the container body has a bottom part, a barrel that is continuous with the bottom part and rises upward, and the mouth that is continuous with the barrel and rises obliquely upward, and the angle of intersection between the axis of the container body, which is perpendicular to the surface of the bottom part of the container body, and the axis of the mouth passing through the center of the mouth, forms an obtuse angle.

2. The writing instrument recited in claim 1, wherein
balls for stirring writing ink are accommodated in the container body, and the spherical diameter of the stirring balls is desirably larger than the opening diameter, facing the inside of the container, of the writing part supporting the writing body and attached to the mouth.

3. The writing instrument recited in claim 1 or claim 2,
wherein the writing body attached as to close the mouth is composed of a flexible foamed material.

4. The writing instrument recited in claim 1, wherein titanium oxide is blended in the writing ink.

5. The writing instrument recited in claim 1, wherein
the container body and the cap member attached to the mouth of the container body are covered with a wrapping sheet in a state of close contact, and
the wrapping sheet has a cutting line and a portion of the wrapping sheet covering the cap member side can be peeled off by the cutting line, and the cutting line is formed along the smallest cross-sectional portion of the container body between the barrel and the mouth of the container body in parallel to the bottom part of the container body.

6. The writing body recited in claim 1,
wherein an extension writing unit capable of receiving the ink exuded from the writing body and supplying it to the writing surface is detachably attached to the mouth of the container body as an attachment.

7. A writing part replacement unit of the writing instrument recited in claim 1, comprising:
a writing part removal cap member screwed to the mouth of the container body and having an opening on the top surface thereof;
a writing part puller formed in a cylindrical shape, one end of which is to be inserted into the opening of the writing part removal cap member, at the one end of which a deflection portion deflectable toward the axial direction is formed, and the deflection portion has a locking portion lockable with the writing part attached to the mouth of the container body;
a deflection-preventing rod that prevents the deflection movement toward the axial direction of the deflection portion by being inserted into the axial hole of the writing part puller having a cylindrical shape; and
a spring member that is mounted to surround the writing part puller between the top surface of the writing part removal cap member and the other end of the writing part puller.
